(19) United States
(12) Patent Application Publication
(10) Pub. No.: US 2023/0384220 A1
(43) Pub. Date: Nov. 30, 2023

(54) INFORMATION PROCESSING APPARATUS, INFORMATION PROCESSING METHOD, AND PROGRAM

(71) Applicant: SONY GROUP CORPORATION, TOKYO (JP)

(72) Inventors: TOMOYUKI UMETSU, TOKYO (JP); KENJI YAMANE, KANAGAWA (JP)

(21) Appl. No.: 18/042,647

(22) PCT Filed: Jul. 20, 2021
(86) PCT No.: PCT/JP2021/027104

§ 371 Date: Feb. 23, 2023

(30) Foreign Application Priority Data
Sep. 7, 2020 (JP) 2020-149737

(51) Int. Cl. G01N 21/64

(52) U.S. Cl. CPC G01N 21/6428; G01N 2021/6439; G01N 2201/126; G01N 15/1429

(57) ABSTRACT

A main object of the present technology is to provide a technique for automatically proposing a better combination of fluorochrome-labeled antibodies.

The present technology provides an information processing apparatus including a processing unit that generates a combination list of fluorophores for a biomolecule on the basis of an expression level category obtained by classifying a plurality of biomolecules used for analysis of a sample on the basis of an expression level in the sample, a brightness category obtained by classifying a plurality of fluorophores usable for analysis of the sample on the basis of brightness, correlation information between the plurality of fluorophores, and expression relationship information of the plurality of biomolecules, in which the processing unit selects a fluorophore to be assigned to the biomolecule in the combination list from fluorophores belonging to a brightness category associated with an expression level category to which the biomolecule belongs.

### TECHNICAL FIELD

The present technology relates to an information processing apparatus, an information processing method, and a program. More specifically, the present technology relates to an information processing apparatus, an information processing method, and a program that propose a method of assigning a fluorophore to a biomolecule.

### BACKGROUND ART

For example, a particle population such as cells, microorganisms, and liposomes is labeled with a fluorescent dye, and the intensity and/or pattern of fluorescence generated from the fluorescent dye excited by irradiating each particle of the particle population with laser light is measured, thereby measuring the characteristics of the particles. As a representative example of a particle analyzer that performs the measurement, a flow cytometer can be mentioned.

The flow cytometer is a device that irradiates particles flowing in a line in a flow path with laser light (excitation light) having a specific wavelength and detects fluorescence and/or scattered light emitted from each particle to analyze a plurality of particles one by one. The flow cytometer can convert light detected by the photodetector into an electrical signal, quantify the electrical signal, and perform statistical analysis to determine characteristics, for example, the type, size, structure, and the like of each particle.

Several techniques have been proposed so far regarding a method for selecting a fluorescent dye used for labeling a particle population to be analyzed by a flow cytometer. For example, Patent Document 1 below describes a method of designing a probe panel of a flow cytometer, the method including: determining a strain factor that quantifies a leakage effect into a second channel caused by emission of a first label intended to be measured in a first channel; inputting a predicted maximum signal of a first probe-label combination including the first label and a first probe; calculating an increase in a detection limit in the second channel on the basis of the strain factor and the predicted maximum signal of the first probe-label combination; and selecting a probe-label combination included in the probe panel on the basis of the calculated increase in the detection limit.

### CITATION LIST

### Patent Document

Patent Document 1: Japanese Patent Application National Publication (Laid-Open) No. 2016-517000

### SUMMARY OF THE INVENTION

### Problems to be Solved by the Invention

In order to label the particle population to be analyzed by the flow cytometer, a plurality of fluorochrome-labeled antibodies is often used. The determination process of the combination of fluorochrome-labeled antibodies used in the analysis is also called panel design. The number of fluorochrome-labeled antibodies used in the analysis tends to increase, and as the number increases, panel design becomes more difficult.

Therefore, a main object of the present technology is to provide a method for automatically proposing a better combination of fluorochrome-labeled antibodies.

### Solutions to Problems

The present technology provides an information processing apparatus including a processing unit that generates a combination list of fluorophores for a biomolecule on the basis of an expression level category obtained by classifying a plurality of biomolecules used for analysis of a sample on the basis of an expression level in the sample, a brightness category obtained by classifying a plurality of fluorophores usable for analysis of the sample on the basis of brightness, correlation information between the plurality of fluorophores, and expression relationship information of the plurality of biomolecules, in which the processing unit selects a fluorophore to be assigned to the biomolecule in the combination list from fluorophores belonging to a brightness category associated with an expression level category to which the biomolecule belongs.

The processing unit may evaluate separation ability related to the combination list using the expression relationship information.

The processing unit may specify a fluorophore pair to be evaluated in evaluation of the separation ability by using the expression relationship information.

An evaluation index in the evaluation of the separation ability may be an inter-fluorophore stain index, and the processing unit may refer to the inter-fluorophore stain index of the fluorophore pair specified in the evaluation of the separation ability.

The expression relationship information may have a tree structure.

The expression relationship information may include information regarding presence or absence or degree of expression of each biomolecule.

The expression relationship information may include expression relationship information extracted from measurement result data assumed to be acquired.

The expression relationship information may include expression relationship information extracted from acquired measurement result data.

The processing unit may cause an output device to output a screen that receives an input of measurement result data assumed to be acquired.

The processing unit may extract the expression relationship information from the acquired measurement result data, and evaluate the separation ability related to the combination list using the expression relationship information extracted.

The processing unit may further use combination information regarding a combination of biomolecules to be output in specifying an evaluation target in the evaluation of the separation ability.

The processing unit may perform evaluation of the separation ability using the expression relationship information for all combination lists that can be generated on the basis of the expression level category and the brightness category.

The processing unit may specify an optimal combination list from all the combination lists on the basis of an evaluation result of the separation ability.

The processing unit may cause an output device to output a result of fluorescence separation simulation executed using the combination list.

The processing unit may use, as simulation data used to execute the fluorescence separation simulation, data related to particles stained by a one-color absent fluorophore group in which one fluorophore is absent from among fluorophore groups constituting the combination list.

The processing unit may cause an output device to output a distribution diagram obtained by dimensionally compressing a result of the fluorescence separation simulation.

The processing unit may cause an output device to output, as a numerical value, a separation degree of each cluster in a distribution diagram acquired by dimensionally compressing a result of the fluorescence separation simulation.

Furthermore, the present technology also provides an information processing method including a list generation step of generating a combination list of fluorophores for a biomolecule on the basis of an expression level category obtained by classifying a plurality of biomolecules used for analysis of a sample on the basis of an expression level in the sample, a brightness category obtained by classifying a plurality of fluorophores usable for analysis of the sample on the basis of brightness, correlation information between the plurality of fluorophores, and expression relationship information of the plurality of biomolecules, in which in the list generation step, a fluorophore to be assigned to the biomolecule in the combination list is selected from fluorophores belonging to a brightness category associated with an expression level category to which the biomolecule belongs.

Furthermore, the present technology also provides a program for causing an information processing apparatus to execute a list generation step of generating a combination list of fluorophores for a biomolecule on the basis of an expression level category obtained by classifying a plurality of biomolecules used for analysis of a sample on the basis of an expression level in the sample, a brightness category obtained by classifying a plurality of fluorophores usable for analysis of the sample on the basis of brightness, correlation information between the plurality of fluorophores, and expression relationship information of the plurality of biomolecules, in which in the list generation step, a fluorophore to be assigned to the biomolecule in the combination list is selected from fluorophores belonging to a brightness category associated with an expression level category to which the biomolecule belongs.

Furthermore, the present technology also provides an information processing apparatus including a processing unit that executes evaluation of separation ability regarding a combination list of fluorophores for a biomolecule in which a fluorophore is assigned to a plurality of biomolecules used for analysis of a sample, in which the processing unit evaluate the separation ability related to the combination list using expression relationship information of the plurality of biomolecules.

### BRIEF DESCRIPTION OF DRAWINGS

FIG. 1 is a schematic diagram of a configuration of a flow cytometer.

FIG. 2 is a diagram illustrating an experimental flow example in a case where the present technology is applied to flow cytometry.

FIG. 3 is a diagram illustrating an example of a gating operation.

FIG. 4 is a diagram illustrating various blood cells and surface markers characterizing each blood cell.

FIG. 5 is a diagram illustrating a configuration example of an information processing apparatus according to the present technology.

FIG. 6 is an example of a flowchart of processing executed by the information processing apparatus according to the present technology.

FIG. 7A is a diagram for explaining information processing according to the present technology.

FIG. 7B is a diagram illustrating an example of a window for receiving input of expression relationship information.

FIG. 7C is a diagram illustrating an example of how to specify biomolecule pairs based on expression relationship information.

FIG. 7D is a diagram illustrating an example of an output result.

FIG. 8 is a diagram illustrating a matrix of correlation coefficient square values.

FIG. 9 is a diagram for explaining a stain index.

FIG. 10 is a diagram illustrating an example of an inter-fluorophore stain index matrix.

FIG. 11 is a diagram illustrating processing of changing fluorophores constituting a combination list.

FIG. 12 is a diagram illustrating an example of an optimized combination list.

FIG. 13 is an example of a flowchart of processing executed by the information processing apparatus according to the present technology.

FIG. 14 is a flowchart illustrating an example of adjustment processing of a fluorophore combination.

FIG. 15 is a conceptual diagram for explaining how to assign fluorophores to biomolecules.

FIG. 16 is a diagram illustrating an example of data of inter-fluorophore SI.

FIG. 17 is a diagram illustrating an example of a window in which a candidate fluorophore that substitutes a fluorophore having poor separation performance is displayed.

FIG. 18A is a diagram illustrating calculation results of inter-fluorophore SI.

FIG. 18B is a diagram illustrating calculation results of inter-fluorophore SI.

FIG. 19 is an example of a flowchart of processing executed by the information processing apparatus according to the present technology.

FIG. 20 is a diagram for explaining how to specify an evaluation target based on expression relationship information and combination information.

FIG. 21 is a diagram illustrating an example of a screen for receiving input of information for generating assumed measurement result data.

FIG. 22 is a diagram illustrating an example of a window to which assumed measurement result data is input.

FIG. 23 is a diagram illustrating an example of expression relationship information and combination information extracted from assumed measurement result data.

FIG. 24 is a diagram illustrating an example of acquired measurement result data.

FIG. 25 is a diagram illustrating an example of expression relationship information and combination information extracted from acquired measurement result data.

FIG. 26 is a diagram illustrating a configuration example of single staining simulation data.

FIG. 27 is a diagram illustrating a configuration example of FMO simulation data.

FIG. 28 is a diagram illustrating single staining simulation results.

FIG. 29 is a diagram illustrating FMO simulation results.

FIG. 30 is a diagram for explaining a method of quantifying a separation degree in a distribution diagram.

FIG. 31 illustrates a distribution diagram obtained by performing tSNE dimensional compression on single staining simulation results.

FIG. 32 illustrates a distribution diagram obtained by performing tSNE dimensional compression on FMO simulation results.

FIG. 33 is a diagram illustrating scattergrams generated using FMO simulation data regarding a combination list of Experimental Example 1.

FIG. 34 is a diagram illustrating scattergrams generated using FMO simulation data regarding a combination list of Experimental Example 2.

FIG. 35 is a diagram illustrating distribution diagrams obtained by performing tSNE dimensional compression on scattergram groups and values of DB-Indexes calculated from the distribution diagrams.

### MODE FOR CARRYING OUT THE INVENTION

Hereinafter, preferred embodiments for carrying out the present technology will be described. Note that the embodiments described below illustrate representative embodiments of the present technology, and the scope of the present technology is not limited only to these embodiments. Note that the present technology will be described in the following order.

1. First Embodiment (Information Processing Apparatus)
(1) Details of Problems of Invention
(2) Example of Flow of Experiment Performed Using Present Technology
(3) Description of First Embodiment
(3-1) Configuration Example of Information Processing Apparatus
(3-2) Example of Processing by Processing Unit (Processing Flow)
(3-3) Example of Processing by Processing Unit (Adjustment Processing of Fluorophore Combination)
(3-4) Example of Processing by Processing Unit (Input of Axis Information)
(3-5) Example of Processing by Processing Unit (Input of Expression Relationship Information Based on Expected Result)
(3-6) Example of Processing by Processing Unit (Input of Expression Relationship Information Based on Measurement Result)
(3-7) Example of Processing by Processing Unit (FMO Simulation)
(3-8) Example of Processing by Processing Unit (Dimensional Compression)
(Example 1: Improvement in Separation Performance by Using Tree Information)
(Example 2: Visualization and Quantification of Separation Performance by tSNE Dimensional Compression of FMO Simulation Results)

2. Second Embodiment (Information Processing System)

3. Third Embodiment (Information Processing Method)

4. Fourth Embodiment (Program)

### 1. First Embodiment (Information Processing Apparatus)

### (1) Details of Problems of Invention

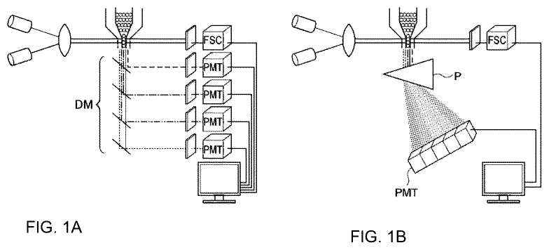

The flow cytometer can be roughly classified into a filter type and a spectral type, for example, from the viewpoint of an optical system of fluorescence measurement. The filter-type flow cytometer can adopt a configuration as illustrated in 1 of FIG. 1 in order to extract only target light information from a target fluorescent dye. Specifically, light generated by irradiating the particles with light is branched into a plurality of pieces by a wavelength separation unit DM such as a dichroic mirror, passed through different filters, and then each branched light is measured by a plurality of detectors, for example, a photomultiplier tube PMT. That is, in the filter-type flow cytometer, fluorescence detection of multiple colors is performed by performing fluorescence detection for each wavelength band corresponding to each fluorescent dye using a detector corresponding to each fluorescent dye. At that time, in a case where a plurality of fluorescent dyes having close fluorescence wavelengths is used, fluorescence correction processing can be performed in order to calculate a more accurate amount of fluorescence. However, in a case where a plurality of fluorescent dyes whose fluorescence spectra are very close to each other is used, leakage of fluorescence to detectors other than the detector to be detected increases, and thus an event in which fluorescence correction cannot be performed may also occur.

The spectral-type flow cytometer analyzes the amount of fluorescence of each particle by performing deconvolution (unmixing) on fluorescence data obtained by detecting light generated by irradiating the particles with light using spectrum information of the fluorescent dye used for staining. As illustrated in 2 of FIG. 1, the spectral-type flow cytometer disperses fluorescence using a prism spectroscopic optical element P. Furthermore, in order to detect the dispersed fluorescence, the spectral-type flow cytometer includes an array-type detector, for example, an array-type photomultiplier tube PMT or the like is provided instead of a large number of photodetectors of the filter-type flow cytometer. The spectral-type flow cytometer is more likely to avoid the influence of leakage of fluorescence than the filter-type flow cytometer, and is more suitable for analysis using a plurality of fluorescent dyes.

In order to advance comprehensive interpretation in basic medicine and clinical fields, multicolor analysis using a plurality of fluorescent dyes has become widespread also in flow cytometry. However, when a large number of fluorescent dyes are used in one measurement as in multicolor analysis, as described above, fluorescence from a fluorescent dye other than a target fluorescent dye leaks into each detector, and analysis accuracy decreases in the filter-type flow cytometer. In a case where the number of colors is large, the problem of leakage of fluorescence can be solved to some extent by using the spectral-type flow cytometer. However, in order to perform more appropriate multicolor analysis, an appropriate panel design (combination design of fluorescent dye and antibody) in which the fluorescence spectrum shape, the antibody expression level, and the brightness of the fluorescent dye are taken into consideration is required.

Conventionally, panel design largely depends on user's experience and adjustment by trial and error. However, as the number of colors increases, particularly when the number of colors is about 20 or more, the number of combinations of fluorescent dyes to be considered rapidly increases, and thus it is extremely difficult to find an optimal dye combination having sufficient decomposition performance.

Device manufacturers that sell flow cytometers, reagent manufacturers that sell antibodies with fluorescent dyes, and the like disclose web tools for panel design for promoting their products. However, as the number of colors increases, these web tools may not exhibit sufficient practicality.

When the number of colors is, for example, 10 or more, it is not possible to avoid occurrence of a large overlap between fluorescence spectra, and it is difficult for a person to predict fluorescence leakage that actually occurs from appearance overlap of spectra. One parameter can be adjusted manually by a person to some extent, but there is a plurality of parameters to be adjusted independently in the panel design of the multicolor analysis. Main examples of the parameters to be considered include, for example, the fluorescence spectrum shape, the expression level of the antigen, and the brightness of the fluorescent dye described above. Furthermore, it is also desirable to consider the excitation properties, availability and costs of the fluorescent dyes. Therefore, it is very difficult to determine which fluorescent dye should be preferentially adopted and to predict the influence on the whole by changing a combination of some fluorescent dyes. The basic principle of fluorescence correction and independent information regarding each fluorescent dye and antigen are not sufficient for an appropriate panel design, and it is extremely difficult to manually find an optimal combination. Since the number of panel candidates generated in consideration of the plurality of parameters described above is enormous, it is considered that if a better panel can be automatically presented, it can contribute to a significant reduction in the burden on the user.

### (2) Example of Flow of Experiment Performed Using Present Technology

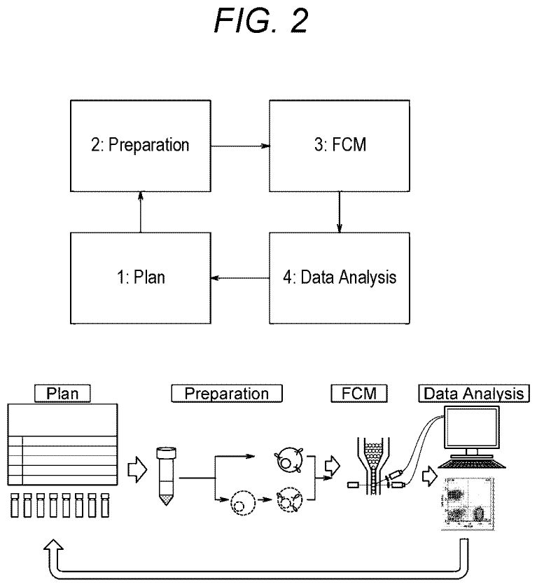

As described above, the present technology may be used to generate a list of combinations of antibodies and fluorophores used in particle analysis such as flow cytometry. An experimental flow example in the case of applying the present technology in flow cytometry will be described with reference to FIG. 2.

The flow of the experiment using the flow cytometer is roughly classified into an experiment planning step (“1: Plan” in FIG. 2) of preparing an antibody reagent with a fluorescence index by examining a cell to be an experiment target and a method for detecting the cell, a sample preparation step (“2: Preparation” in the figure) of actually staining and preparing the cell in a state suitable for measurement, an FCM measurement step (“3: FCM” in the figure) of measuring the amount of fluorescence of each stained cell by the flow cytometer, and a data analysis step (“4: Data Analysis” in the figure) of performing various data processing so as to obtain a desired analysis result from data recorded by FCM measurement. Then, these steps can be repeated as necessary.

In the experiment planning step, first, which molecule (for example, an antigen, a cytokine, or the like) expression is used to determine a microparticle (mainly a cell) that is intended to be detected using a flow cytometer, that is, a marker used in detection of the microparticle is determined. The determination can be made on the basis of, for example, information such as past experimental results and papers. Next, which fluorescent dye is used to detect the marker is examined. Information such as the number of markers desired to be detected at the same time, specifications of usable FCM devices, commercially available fluorescently labeled reagents, and spectrum, brightness, price, and delivery date of the fluorescent dyes is comprehensively determined, and a combination of fluorescently labeled antibody reagents necessary for actual experiments is determined. The process of determining this combination of reagents is commonly referred to as panel design in FCM. Here, a reagent that is insufficient among a set of reagents determined by the panel design is ordered to a reagent manufacturer and purchased. However, fluorescently labeled antibody reagents are expensive, and relatively rare reagents and the like may take one month or more from order placement to delivery. Therefore, it is not realistic to perform trial and error by repeating the above four steps many times. It is desirable to obtain desired results with fewer experiment planning steps.

In the sample preparation step, the experiment target is first processed into a state suitable for FCM measurement. For example, cell separation and purification may be performed. For example, for immune cells derived from blood or the like, red blood cells are removed from the blood by hemolysis and density gradient centrifugation, and white blood cells are extracted. The extracted cell group of the target is stained using a fluorescently labeled antibody. At this time, in addition to the sample to be analyzed that is simultaneously stained with a plurality of fluorescent dyes, it is generally recommended to prepare a single stained sample that is stained with only one fluorescent dye used as a reference at the time of analysis and a non-stained sample that is not stained at all.

In the FCM measurement step, when the microparticle is optically analyzed, first, excitation light is emitted from a light source of a light irradiation unit of the flow cytometer, and the microparticle flowing in the flow path is irradiated with the excitation light. Next, fluorescence emitted from the microparticle is detected by a detection unit of the flow cytometer. Specifically, using a dichroic mirror, a bandpass filter, or the like, only light of a specific wavelength (target fluorescence) is separated from light emitted from the microparticle, and the separated light is detected by a detector such as a 32 channel PMT. At this time, for example, fluorescence is dispersed using a prism, a diffraction grating, or the like, and light having different wavelengths is detected in each channel of the detector. Therefore, spectrum information of detection light (fluorescence) can be easily obtained. The microparticle to be analyzed is not particularly limited, and examples thereof include cells and microbeads.

The flow cytometer may have a function of recording fluorescence information of each fine particle acquired by FCM measurement together with scattered light information, time information, and position information other than the fluorescence information. The recording function can be mainly executed by a memory or a disk of a computer. In normal cell analysis, since analysis of several thousand to several million microparticles is performed under one experimental condition, it is necessary to record a large number of pieces of information in an organized state for each experimental condition.

In the data analysis step, light intensity data in each wavelength region detected in the FCM measurement step is quantified using a computer or the like, and the amount of fluorescence (intensity) for each fluorescent dye used is obtained. For this analysis, a correction method using a criterion calculated from experimental data is used. The standard is calculated by statistical processing using two types of measurement data of microparticles stained with only one fluorescent dye and measurement data of unstained microparticles. The calculated amount of fluorescence can be recorded in a data recording unit provided in the computer together with information such as the name of the fluorescent molecule, the measurement date, and the type of the microparticle. The amount of fluorescence (fluorescence spectrum data) of the sample estimated by the data analysis is stored and displayed as a graph according to the purpose, and the fluorescence amount distribution of the microparticle is analyzed.

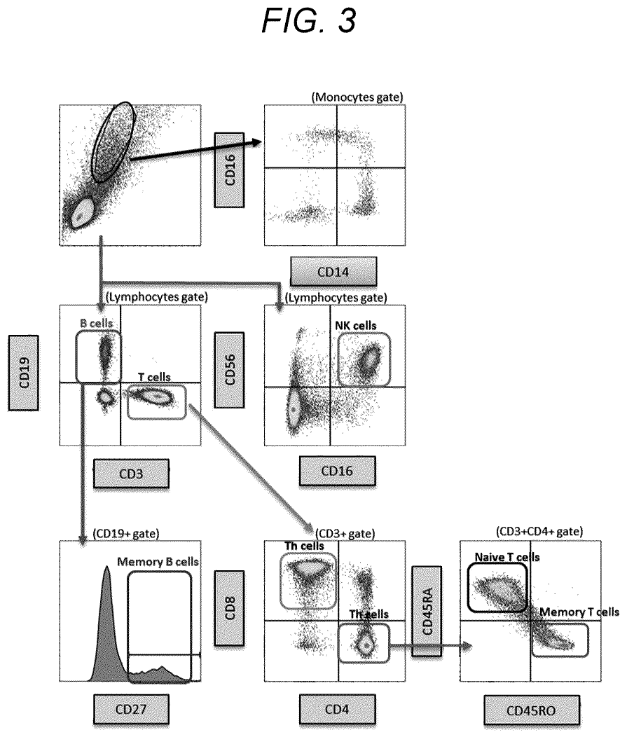

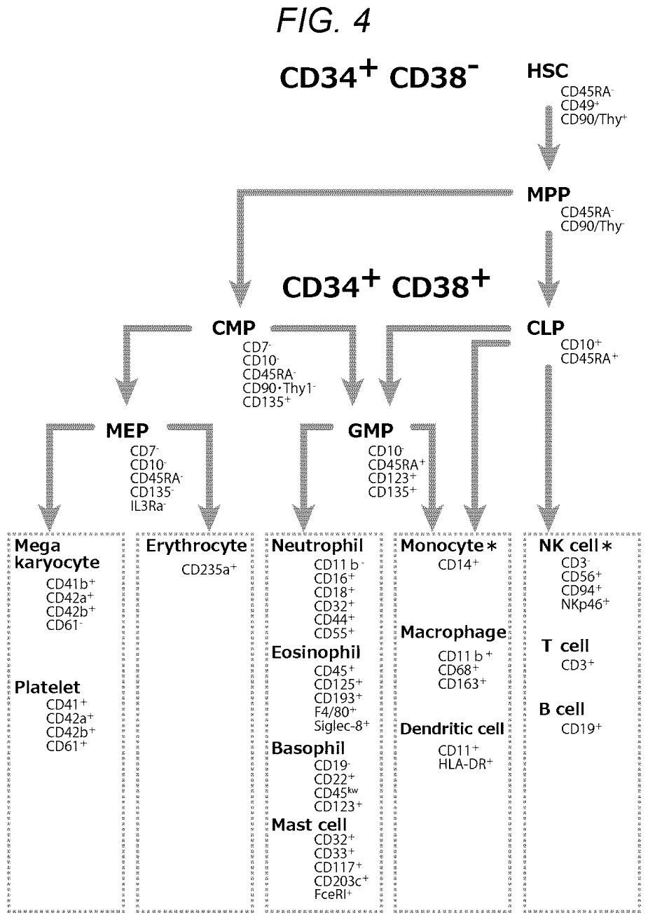

For example, gate setting is often performed for analysis of the fluorescence amount distribution, whereby the proportion of the detection target cells in the sample can be calculated. For example, as illustrated in FIG. 3, a two-dimensional plot regarding the forward scattered light (FSC) and the side scattered light (SSC) is generated, and a predetermined range is selected from the plot, whereby the ratio of monocytes and lymphocytes in the blood cells contained in PBMCs can be specified. Furthermore, the ratio of B cells, T cells, and NK cells among lymphocytes can be calculated by gate setting and development for lymphocytes expressing a predetermined surface marker. Furthermore, the ratio of memory B cells among B cells, the ratio of killer T cells and helper T cells among T cells, and the ratio of naïve T cells and memory T cells can also be specified. It is known that the surface marker expressed by each type of cell varies depending on the cell type, for example, as illustrated in FIG. 4. Therefore, the antibody that binds to the surface marker and the fluorescent dye that labels each antibody are appropriately selected and then analysis is performed by the flow cytometer, whereby the cells in the sample can be examined.

The present technology can be used for panel design in an experiment planning step. For example, the information processing apparatus according to the present technology can receive an input of biomolecules and expression levels of the biomolecules in a measurement target by a user, and can automatically generate an optimized FCM experimental panel using input data. That is, it can be said that the information processing apparatus of the present technology is an apparatus having an optimization algorithm for generating the panel.

Furthermore, as another example of particle analysis to which the present technology is applied, a microparticle sorting device that sorts microparticles in a closed space can be mentioned. For example, in order to determine whether to sort the microparticles, the device may include a chip that has a flow path through which the microparticles flow and in which the microparticles are sorted, a light irradiation unit that irradiates the microparticles flowing through the flow path with light, a detection unit that detects light generated by the light irradiation, and a determination unit that determines whether to sort the microparticles on the basis of information regarding the detected light. Examples of the microparticle sorting device include a device described in Japanese Patent Application Laid-Open No. 2020-041881.

Furthermore, the analysis to which the present technology is applied is not limited to particle analysis. That is, the present technology may be used in various types of processing in which assignment of a fluorophore to a biomolecule is required. For example, in microscopic analysis or observation of a cell sample or a tissue sample, such as multicolor fluorescence imaging, assignment processing of a fluorophore to a biomolecule according to the present technology may be performed in order to stain these samples. In recent years, the number of fluorophores used in fluorescence imaging also tends to increase, and the present technology can also be used in such analysis or observation.

### (3) Description of First Embodiment

An information processing apparatus according to the present technology includes a processing unit that generates a combination list of fluorophores for a biomolecule. The processing unit generates the combination list on the basis of an expression level category obtained by classifying a plurality of biomolecules used for analysis of a sample on the basis of an expression level in the sample, a brightness category obtained by classifying a plurality of fluorophores usable for analysis of the sample on the basis of brightness, correlation information between the plurality of fluorophores, and expression relationship information of the plurality of biomolecules. In the generation, the processing unit selects a fluorophore to be assigned to the biomolecule in the combination list from fluorophores belonging to a brightness category associated with an expression level category to which the biomolecule belongs.

By generating the combination list as described above, a more appropriate combination list can be generated, and the processing for the generation is more efficiently performed. Therefore, it is possible to automatically perform the optimized panel design. For example, by utilizing the expression relationship information, a more suitable panel is automatically generated, for example, for analysis of expression of a biomolecule to be analyzed. For example, a panel considering an expression state of a biomolecule in a cell can be automatically generated.

According to the present technology, for example, by inputting a marker expression state of the cell to be analyzed in addition to the antibody desired to be used in flow cytometry and the expected expression level thereof, an FCM panel suitable for the purpose of analysis of the user is automatically designed. Therefore, it is possible to greatly reduce the time, labor, and cost for preparation that are conventionally required.

### (3-1) Configuration Example of Information Processing Apparatus

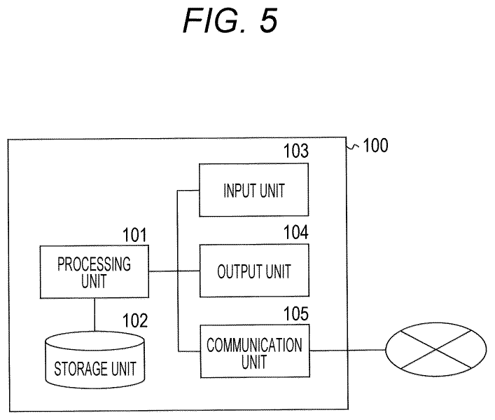

An example of an information processing apparatus according to the present technology will be described with reference to FIG. 5. FIG. 5 is a block diagram of the information processing apparatus. The information processing apparatus 100 illustrated in FIG. 5 can include a processing unit 101, a storage unit 102, an input unit 103, an output unit 104, and a communication unit 105. The information processing apparatus 100 may be configured by, for example, a general-purpose computer.

The processing unit 101 is configured to be able to generate a combination list of fluorophores for biomolecules. The process of generating the combination list will be described in detail below. The processing unit 101 can include, for example for example, a central processing unit (CPU) and a RAM. The CPU and the RAM may be connected to each other via, for example, a bus. An input/output interface may be further connected to the bus. The input unit 103, the output unit 104, and the communication unit 105 may be connected to the bus via the input/output interface.

The storage unit 102 stores various data. The storage unit 102 may be configured to be able to store, for example, data acquired in processing to be described later and/or data generated in processing to be described later, or the like. Examples of these data include, but are not limited to, various data received by the input unit 103 (for example, biomolecule data, expression level data, and expression relationship information or data used for generating expression relationship information), various data received by the communication unit 105 (for example, a list related to fluorophores), and various data generated by the processing unit 101 (for example, an expression level category, a brightness category, correlation information, a combination list, and the like). Furthermore, the storage unit 102 can store an operating system (for example, Windows (registered trademark), UNIX (registered trademark), Linux (registered trademark), or the like), a program for causing the information processing apparatus or the information processing system to execute the information processing method according to the present technology, and various other programs.

The input unit 103 may include an interface configured to be able to receive inputs of various data. For example, the input unit 103 may be configured to be able to receive various data input in processing to be described later. Examples of the data include biomolecule data and expression level data. Furthermore, examples of the data also include expression relationship information or data used to generate expression relationship information. The input unit 103 may include, for example, a mouse, a keyboard, a touch panel, and the like as a device that receives such an operation.

The output unit 104 may include an interface configured to be able to output various data. For example, the output unit 104 may be configured to be able to output various data generated in processing to be described later. Examples of the data include, but are not limited to, various data (for example, expression level category, brightness category, correlation information, expression relationship information, combination list, and the like) generated by the processing unit 101. The output unit 104 can include, for example, a display device as a device that outputs the data.

The communication unit 105 may be configured to connect the information processing apparatus 100 to a network in a wired or wireless manner. By the communication unit 105, the information processing apparatus 100 can acquire various data (for example, a list related to a fluorophore) via a network. The acquired data can be stored in, for example, the storage unit 102. The configuration of the communication unit 105 may be appropriately selected by those skilled in the art.

The information processing apparatus 100 may include, for example, a drive (not illustrated) or the like. The drive can read data (for example, the various data listed above) or a program (for example, the program described above) recorded in the recording medium and output the read data or program to the RAM. The recording medium is, for example, a microSD memory card, an SD memory card, or a flash memory, but is not limited thereto.

### (3-2) Example of Processing by Processing Unit (Processing Flow)

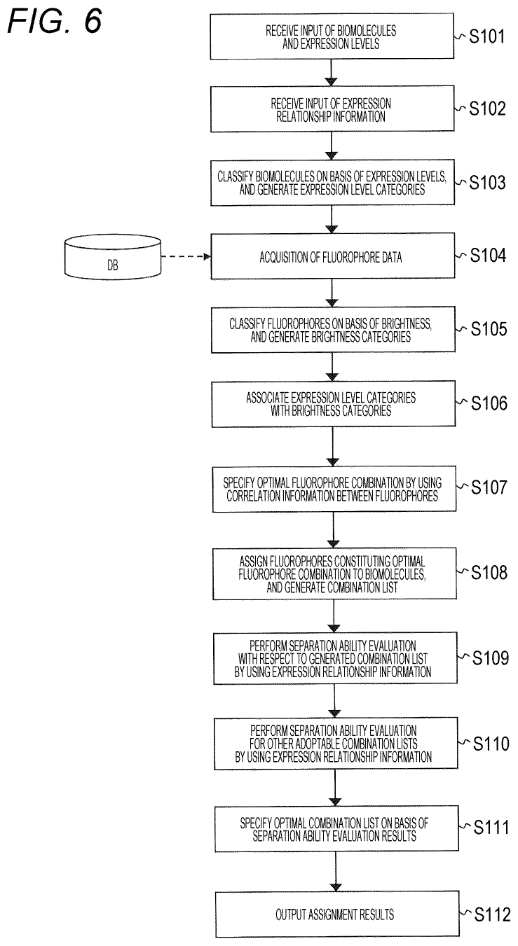

Processing executed by the processing unit will be described below with reference to FIG. 6. FIG. 6 is a flowchart of the processing. The following description relates to an application example of the present technology in the case of optimizing a combination of an antibody and a fluorescent dye used in flow cytometry.

In step S101 of FIG. 6, the information processing apparatus 100 (in particular, the input unit 103) receives inputs of a plurality of biomolecules and expression levels of the plurality of biomolecules.

The biomolecules may be antigens to be measured in flow cytometry (for example, surface antigens, cytokines, or the like), or may be antibodies that capture antigens to be measured. In a case where the plurality of biomolecules is antigens, the expression levels may be expression levels of the antigens. In a case where the plurality of biomolecules is antibodies, the expression levels may be expression levels of antigens captured by the antibodies.

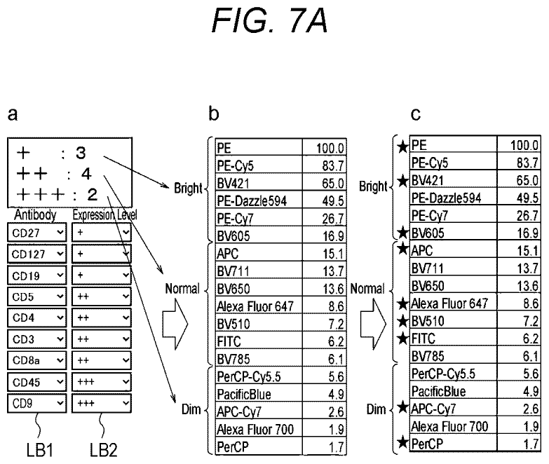

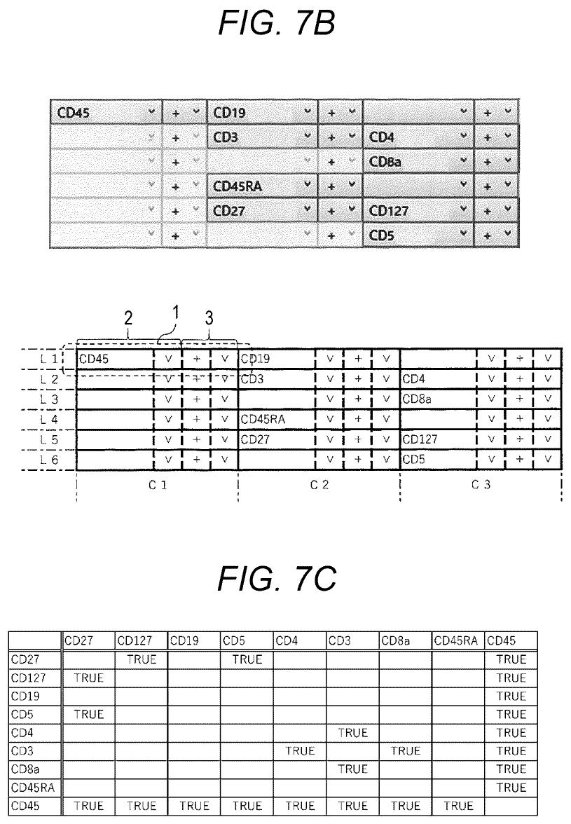

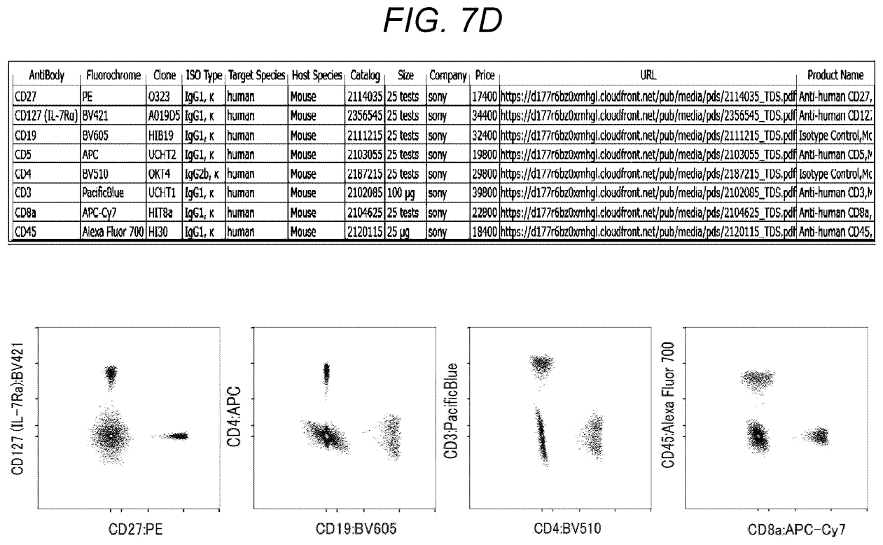

The processing unit 101 can display an input receiving window for receiving the input on the output unit 104 (particularly, a display device) to prompt the user to perform the input. The input receiving window may include, for example, a biomolecule input receiving field and an expression level receiving field such as an “Antibody” field and an “Expression Level” field illustrated in a of FIG. 7A.

The biomolecule input receiving field may be, for example, a plurality of list boxes LB1 prompting selection of a biomolecule, as illustrated in the “Antibody” field in a of FIG. 7A. In a of FIG. 7A, nine list boxes are described for convenience of description, but the number of list boxes is not limited thereto. The number of list boxes may be, for example, five to 300 or 10 to 200.

In response to the user enabling each list box by an operation such as clicking or touching, the processing unit 101 displays a list of options of biomolecules above or below the list box. In response to the user selecting one biomolecule from the list, the list is closed and the selected biomolecule is displayed.

In a of FIG. 7A, the screen after selection of biomolecules by the user is displayed. In response to the selection of antigens to be captured by antibodies, as illustrated in the figure, for example, “CD27”, “CD127” or the like is displayed.

Furthermore, the expression level receiving field may be, for example, a plurality of list boxes LB2 prompting selection of an expression level, as illustrated in the “Expression Level” field in a of FIG. 7A. The number of the list boxes LB2 prompting the selection of the expression level may be the same as the number of the list boxes LB1 prompting the selection of the biomolecule. In a of FIG. 7A, nine list boxes are described for convenience of description, but the number of list boxes is not limited thereto. The number of list boxes may be, for example, five to 300 or 10 to 200.

In response to the user enabling each list box by an operation such as clicking or touching, the processing unit 101 displays a list of options of expression levels above or below the list box. In response to the user selecting one biomolecule from the list, the list is closed and the selected expression level is displayed.

In a of FIG. 7A, a screen after selection of expression levels by the user is displayed. In response to the levels of the expression levels being selected, as illustrated in the figure, for example, “+”, “++”, and “+++” are displayed. In a of FIG. 7A, for example, “+” is selected as the expression level of the biomolecule “CD27”. Furthermore, “++” is selected as the expression level of the biomolecule “CD5”. The symbols “+”, “++”, and “+++” mean that the expression level increases in this order.

In the present specification, the “expression level” may mean, for example, the level of the expression level, or may be a specific numerical value of the expression level. Preferably, as illustrated in a of FIG. 7A above, the expression level means the level of the expression level. The level of expression level may be preferably two to 20 steps, more preferably two to steps, and still more preferably two to 10 steps, and may be divided into, for example, three to 10 steps.

After the selection of the biomolecules and the expression levels is completed as described above, for example, in response to the user clicking a selection completion button (not illustrated) in the input receiving window, the processing unit 101 receives the input of the selected biomolecules and the expression levels.

In step S102 of FIG. 6, the information processing apparatus 100 (in particular, the input unit 103) receives an input of expression relationship information of the plurality of biomolecules. The plurality of biomolecules may be the plurality of biomolecules input in step S101.

The expression relationship information may include “information regarding the type” and “information regarding the presence or absence or degree of expression” of each biomolecule. The information regarding the type can include, for example, a name or an abbreviation of each biomolecule. The information regarding the presence or absence or degree of expression may be, for example, whether the expression of each biomolecule is positive or negative, or how much the expression level of each biomolecule is.

The expression relationship information includes, for example, association information indicating that two or more types of biomolecules among the plurality of biomolecules are associated with each other.

For example, a plurality of biomolecules present in one row or column of the data matrix may be treated as being associated with each other. In this case, row information or column information shared by the plurality of biomolecules may be used as the association information, or other information indicating that the biomolecules exist in one row or column may be used as the association information.

Furthermore, the association information may be information indicating that one bioparticle (for example, a cell) expresses or does not express the two or more types of biomolecules (for example, cell surface markers). Furthermore, the association information may be information indicating that a pair of any two types of biomolecules among the two or more types of biomolecules is an analysis target or information indicating that a pair of biomolecules is a separation ability evaluation target.

An example of a window for receiving the input of expression relationship information is illustrated in the upper part of FIG. 7B. A schematic diagram for explaining the configuration of the window is illustrated in the lower part of FIG. 7B. Hereinafter, the window will be described with reference to the schematic diagram in the lower part of FIG. 7B. The window includes a plurality of cells 1 including a pair of a biomolecule selection field 2 and an expression presence/absence selection field 3. These cells are arranged in a tabular form as illustrated in the figure. The biomolecule selection field may be configured as, for example, a list box that receives selection of a biomolecule. Furthermore, the expression presence/absence selection field may be configured as a list box that receives selection of presence or absence of expression of the selected biomolecule (positive “+” or negative “−”). Note that the expression presence/absence selection field may be configured as a field for receiving selection of the degree of expression.

Each of the columns C1 to C3 of the window represents a hierarchy, for example, a hierarchy in a tree structure. In a case where there is a cell in which a biomolecule and the presence or absence of expression of the biomolecule are selected in a certain row, it means that the same biomolecule and the presence or absence of expression as those of the selected cell are selected for other cells in the same row and existing below the selected cell unless another biomolecule is selected or the presence or absence of expression is changed.

Each of rows L1 to L6 of the window corresponds to, for example, a state of expression of a biomolecule in a cell to be analyzed by the user. That is, the plurality of biomolecules selected in each row is associated with each other.

For example, in the first row L1 of the figure, CD45 and CD19 are selected as biomolecules, and positive “+” is selected as the presence or absence of expression of these two biomolecules. That is, the first row of the figure corresponds to cells that are CD45 positive and CD19 positive. CD45 and CD19 are associated with each other.

Furthermore, since no other biomolecule is selected and the presence or absence of expression is not changed in the first column C1 of the second row L2 of the figure, as in the first row, CD45 is selected as a biomolecule and positive “+” is selected as the presence or absence of expression of CD45. Meanwhile, in the second column C2 in the second row L2, CD3 is selected as the biomolecule, and positive “+” is selected as the presence or absence of expression of CD3. Furthermore, in the third column C3 of the second row L2, CD4 is selected as the biomolecule, and positive “+” is selected as the presence or absence of expression of CD4. As described above, the second row of the figure corresponds to cells that are CD45 positive, CD3 positive, and CD4 positive.

Furthermore, in the third row L3 of the figure, since no other biomolecule is selected and the presence or absence of expression is not changed in the first column C1 and the second column C2, as in the second row, CD45 and CD3 are selected as biomolecules, and positive “+” is selected as the presence or absence of expression of these two biomolecules. Meanwhile, in the third column C3 of the third row L3, unlike the third column of the second row, the biomolecule CD8a is selected, and positive “+” is selected as the presence or absence of expression of CD8a. Therefore, the third row of the figure corresponds to cells that are CD45 positive, CD3 positive, and CD8a positive.

Each of the fourth row L4, the fifth row L5, and the sixth row L6 in the figure also corresponds to cells having expression states of the selected biomolecules as illustrated in each row.

As described above, in FIG. 7B, the expression states of a total of six types of cells are specified by the user.

As described above, in the present technology, the input receiving window for receiving the input of the expression relationship information may be configured to receive the input of the expression relationship information having, for example, a tree structure. The input receiving window may include, for example, a plurality of cells including a pair of a biomolecule selection field and an expression presence/absence selection field in a tabular form.

In the present technology, the expression relationship information preferably has a tree structure. For example, the window that receives the input of the expression relationship information has a hierarchy in the tree structure, for example, as described with reference to FIG. 7B. This hierarchy can simplify the work of selecting the biomolecules. The number of layers included in the tree structure is three in FIG. 7B, but is not limited thereto, and may be appropriately set. The number of layers may be, for example, two to 100, two to 50, two to 40, two to 30, or two to 20.

Furthermore, the window may be configured such that the number of layers included in the input receiving window can be increased or decreased. For example, the input receiving window may have a button to increase or decrease the number of layers. The number of layers may be increased or decreased according to a click of the button by the user.

An example of the input operation of the expression relationship information is as follows, for example.

The user first clicks the biomolecule selection field in the cell in the first row and the first column. In response to the click, the processing unit 101 displays a list box of a list of selectable biomolecules. In response to the user selecting one biomolecule from the list, the list box is closed and the selected biomolecule is displayed. In the first column of FIG. 7B, “CD45” is selected. The list of selectable biomolecules may include, for example, a plurality of biomolecules selected in step S101, and only the plurality of biomolecules may be displayed.

Next, the user clicks the expression presence/absence selection field in the cell. In response to the click, the processing unit 101 displays a list box for selecting the presence or absence of expression of the biomolecule. In response to the user selecting “presence” or “absence” from the list box, the list box is closed, and the selection result of the presence or absence of expression of the biomolecule is displayed. In the first column of FIG. 7B, “+” is selected for “CD45”, and it is selected by the user that there is expression of “CD45”, that is, positive.

Next, in response to the user clicking the biomolecule selection field in the cell in the first row and the second column, the processing unit 101 displays a list box of a list of selectable biomolecules. In response to the user selecting one biomolecule from the list, the list box is closed and the selected biomolecule is displayed. In the list box, biomolecules other than the biomolecule selected in the first column among the plurality of biomolecules selected in step S101 may be displayed.

For example, since “CD45” is already selected in the first column of FIG. 7B, the list of biomolecules that can be selected in the second column may be, for example, biomolecules other than “CD45” among the plurality of biomolecules selected in step S101.

Furthermore, the user also clicks the expression presence/absence selection field for the second column. In response to the click, the processing unit 101 displays a list box for selecting the presence or absence of expression of each biomolecule, similarly to the case of the first column. The selection result of the presence or absence of expression of each biomolecule is displayed according to the selection result by the user.

Also in the third column, the selection of the biomolecule and the presence or absence of expression is performed similarly to the first and second columns. Furthermore, in the second and subsequent rows, the selection of the biomolecule and the presence or absence of expression is similarly performed.

FIG. 7C illustrates an example of a specifying result of biomolecule pairs based on the expression relationship information generated by the input operation to the window illustrated in FIG. 7B. In the matrix data illustrated in FIG. 7C, “TRUE” is displayed in cells corresponding to any two biomolecules among the biomolecules selected in each row of the window. That is, two biomolecules associated with each other are indicated by “TRUE”. Note that the display “TRUE” is merely an example of a mark indicating that they are associated with each other, and may be another display.

In the present technology, the processing unit 101 can specify two biomolecules (that is, a biomolecule pair) associated with each other on the basis of the expression relationship information in this manner. The specified biomolecule pair can be used in specification of a fluorophore pair described later.

Note that the specification of the biomolecule pairs based on the expression relationship information may be performed in step S102 or may be performed in another step. For example, the processing unit 101 may perform the specifying processing in the separation ability evaluation processing in steps S109 and 110 described later.

Details of the specification of the biomolecule pairs will be described below.

For example, in the first row of FIG. 7B, two biomolecules CD45 and CD19 are selected. Therefore, in FIG. 7C, “TRUE” is indicated in the cell of the row of CD45 and the column of CD19 and the cell of the row of CD19 and the column of CD45.

Furthermore, in the second row of FIG. 7B, three biomolecules CD45, CD3, and CD4 are selected. Therefore, in FIG. 7C, “TRUE” is indicated in the cell of the row of CD45 and the column of CD3 and the cell of the row of CD3 and the column of CD45, the cell of the row of CD45 and the column of CD4 and the cell of the row of CD4 and the column of CD45, and the cell of the row of CD4 and the column of CD3 and the cell of the row of CD3 and the column of CD4.

Furthermore, in the third row of FIG. 7B, three biomolecules CD45, CD3, and CD8a are selected. Therefore, in FIG. 7C, “TRUE” is indicated in the cell of the row of CD45 and the column of CD3 and the cell of the row of CD3 and the column of CD45, the cell of the row of CD45 and the column of CD8a and the cell of the row of CD8a and the column of CD45, and the cell of the row of CD8a and the column of CD3 and the cell of the row of CD3 and the column of CD8a.

Similarly, for the biomolecules selected in the fourth to sixth row of FIG. 7B, “TRUE” is illustrated in the corresponding cells in FIG. 7C.

As described above, the processing unit 101 can specify the biomolecule pairs as illustrated in FIG. 7C on the basis of the expression relationship information generated by the input operation to the window of FIG. 7B. Note that the matrix data illustrated in FIG. 7C is merely an example of a display format for facilitating understanding of a situation in which biomolecule pairs are specified, and the specifying result may exist in a format other than the matrix data.

In step S103, the processing unit 101 classifies the plurality of biomolecules selected in step S101 on the basis of the expression level selected for each biomolecule, and generates one or a plurality of expression level categories, particularly a plurality of expression level categories. The number of expression level categories may be, for example, a value corresponding to the number of expression level levels, and may be preferably two or more, and more preferably three or more. The number may be preferably two to 20, preferably three to 15, and even more preferably three to 10.

In a of FIG. 7A, the expression level “+”, “++”, or “+++” is selected for each of the plurality of biomolecules. The processing unit 101 classifies biomolecules whose selected expression level is “+” into an expression level category “+”. Similarly, the processing unit 101 classifies biomolecules whose selected expression level is “++” or “+++” into an expression level category “++” or an expression level category “+++”, respectively. In this way, the processing unit 101 generates three expression level categories. Each expression level category includes biomolecules in which a corresponding expression level is selected. In a of FIG. 7A, three biomolecules at the expression level “+”, four biomolecules at the expression level “++”, and five biomolecules at the expression level “+++” are input.

In step S104, the processing unit 101 acquires a list of fluorophores capable of labeling the biomolecules input in step S101. The list of the fluorophores may be acquired, for example, from a database existing outside the information processing apparatus 100 via the communication unit 105, or may be acquired from a database stored inside the information processing apparatus 100 (for example, the storage unit 102).

The list for the fluorophores may include, for example, a name and brightness for each fluorophore. Furthermore, the list for the fluorophores preferably also includes the fluorescence spectra of each fluorophore. The fluorescence spectrum of each fluorophore may be acquired from the database as data different from the list.

Preferably, the list may selectively include fluorophores that can be used in a device (for example, a microparticle analyzer) in which the sample is analyzed using a combination of biomolecules and fluorophores. Since the fluorophores unusable in the device are deleted from the list, it is possible to reduce the burden on the device in the processing to be described later (in particular, the calculation processing of the correlation information).

In step S105, the processing unit 101 classifies the fluorophores included in the list regarding the fluorophores acquired in step S103 on the basis of the brightness of each fluorophore, and generates one or a plurality of brightness categories, particularly a plurality of brightness categories.

In step S105, preferably, the processing unit 101 generates a brightness categories with reference to the expression level categories generated in step S102. Therefore, it is possible to more efficiently associate the brightness categories to be generated with the expression level categories and generate the combination of the biomolecules and the fluorophores. Specific content of the reference will be described below.

The classification based on the brightness may be classification based on an amount of fluorescence or a fluorescence intensity. In order to perform the classification, for example, a numerical range of the amount of fluorescence or the fluorescence intensity may be associated with each brightness category. Then, the processing unit 101 can classify each of the fluorophores included in the list into a brightness category associated with a numerical range including the amount of fluorescence or the fluorescence intensity with reference to the amount of fluorescence or the fluorescence intensity of each fluorophore.

Preferably, in step S105, the processing unit 101 generates brightness categories with reference to the number of expression level categories generated in step S102. Particularly preferably, in step S105, the processing unit 101 generates the same number of brightness categories as the number of expression level categories generated in step S103. Therefore, the expression level categories and the brightness categories can be associated on a one-to-one basis. In addition, it is possible to prevent generation of fluorophores that are not considered in generation of a combination list to be described later, and it is possible to generate a better combination. The number of brightness categories may be, for example, a value corresponding to the number of expression level categories, and may be preferably two or more, and more preferably three or more. The number may be preferably two to 20, preferably three to 15, and even more preferably three to 10.

For example, as illustrated in b of FIG. 7A, three brightness categories (Bright, Normal, and Dim) may be generated. In these three brightness categories, the brightness decreases in this order, that is, all the fluorophores included in Bright are brighter than any of the fluorophores included in Normal, and all the fluorophores included in Normal are brighter than any of the fluorophores included in Dim.

Preferably, in step S105, the processing unit 101 generates brightness categories with reference to the number of biomolecules included in each of the expression level categories generated in step S103. Particularly preferably, in step S105, the processing unit 101 classifies the fluorophores into the respective brightness categories such that the fluorophores equal to or more than the number of biomolecules included in the expression level categories generated in step S103 are included in the associated brightness categories. Therefore, it is possible to prevent generation of a biomolecule to which a fluorophore is not assigned in generation of a combination list described later.

In step S106, the processing unit 101 associates the expression level categories generated in step S103 with the brightness categories generated in step S105. Preferably, the processing unit 101 associates one expression level category with one brightness category. Furthermore, the processing unit 101 can perform association such that the expression level category and the brightness category correspond on a one-to-one basis. That is, the association can be performed such that two or more expression level categories are not associated with one brightness category.

In a particularly preferred embodiment of the present technology, the processing unit 101 can perform the association such that an expression level category with a smaller expression level is associated with a brighter brightness category. For example, the processing unit 101 associates the expression level category having the smallest expression level with the brightness category having the brightest brightness, and then associates the expression level category having the second smallest expression level with the brightness category having the second brightest brightness, and similarly, this association can be repeated until there are no more expression level categories. Conversely, the processing unit 101 associates the expression level category with the highest expression level with the brightness category with the lowest brightness, and then associates the expression level category with the second highest expression level with the brightness category with the second lowest brightness, and similarly, this association can be repeated until there are no more expression level categories.

In this embodiment, for example, as indicated by arrows between a and b in FIG. 7A, the processing unit 101 associates the expression level categories “+”, “++”, and “+++” with the brightness categories “Bright”, “Normal”, and “Dim”, respectively.

As described above, the expression level categories generated in the present technology may be associated with the brightness categories such that, preferably, an expression level category in which biomolecules exhibiting a smaller expression level are classified corresponds to a brightness category in which brighter fluorophores are classified.

In step S107, the processing unit 101 specifies an optimal fluorophore combination by using correlation information between fluorophores. The optimal fluorophore combination may be, for example, a fluorophore combination that is optimal from the viewpoint of the correlation between the fluorescence spectra, may be more particularly a fluorophore combination that is optimal from the viewpoint of the correlation coefficient between the fluorescence spectra, and may be even more particularly a fluorophore combination that is optimal from the viewpoint of the square of the correlation coefficient between the fluorescence spectra. The correlation coefficient may be, for example, any of a Pearson correlation coefficient, a Spearman correlation coefficient, or a Kendall correlation coefficient, and is preferably a Pearson correlation coefficient.

The correlation information between the fluorophores may be preferably correlation information between fluorescence spectra. That is, in one preferred embodiment of the present technology, the processing unit 101 specifies an optimal fluorophore combination by using correlation information between fluorescence spectra.

For example, the Pearson correlation coefficient can be calculated between the two fluorescence spectra X and Y as follows.

First, the fluorescence spectra X and Y can be expressed as follows, for example.

Fluorescence spectrum X=(X₁, X₂, . . . , X₃₂₀), mean=μₓ, standard deviation=σₓ (where X₁ to X₃₂₀ are fluorescence intensities at 320 different wavelengths, the mean μₓ is a mean of these fluorescence intensities, and the standard deviation σₓ is a standard deviation of these fluorescence intensities).

Fluorescence spectrum Y=(Y₁, Y₂, . . . , Y₃₂₀), mean=μ_{y}, standard deviation=σ_{y} (where Y₁ to Y₃₂₀ are fluorescence intensities at 320 different wavelengths, the mean μ_{y} is a mean of these fluorescence intensities, and

Note that the numerical value “320” is a value set for convenience of description, and the numerical value used in the calculation of the correlation coefficient is not limited thereto. The numerical value may be appropriately changed according to the configuration of the fluorescence detector, for example, the number of PMTs (photomultiplier tubes) used for fluorescence detection and the like.

The Pearson correlation coefficient R between the fluorescence spectra X and Y is obtained by the following Formula 1.

$$R = \frac{\sum {Z}_{Xn} {Z}_{Yn}}{N} \qquad [ Mathematical Formula 1 ]$$

In Formula 1, Z_{Xn} (n is 1 to 320) is a standardized fluorescence intensity and is expressed as follows.

Zx1=(X₁−μₓ)÷σₓ,Zx2=(X₂−μₓ)÷σₓ, . . . Zx320=(X₃₂₀−μₓ)÷σₓ

Similarly, Z_{Yn} (n is 1 to 320) is also expressed as follows.

Zy1=(Y₁−μ_{y})÷σ_{y},Zy2=(Y₂−μ_{y})÷σ_{y}, . . . Zy320=(Y₃₂₀−μ_{y})÷σ_{y}

Furthermore, in Formula 1, N is the number of data.

An example of how to specify the optimal fluorophore combination will be described below.

The processing unit 101 selects the same number of fluorophores as “the number of biomolecules belonging to an expression level category associated with a certain brightness category” from the certain brightness category. The selection of fluorophores is performed for all brightness categories. Therefore, the same number of fluorophores as the “number of a plurality of biomolecules used for analysis of a sample” are selected, and in this manner, one fluorophore combination candidate is obtained.

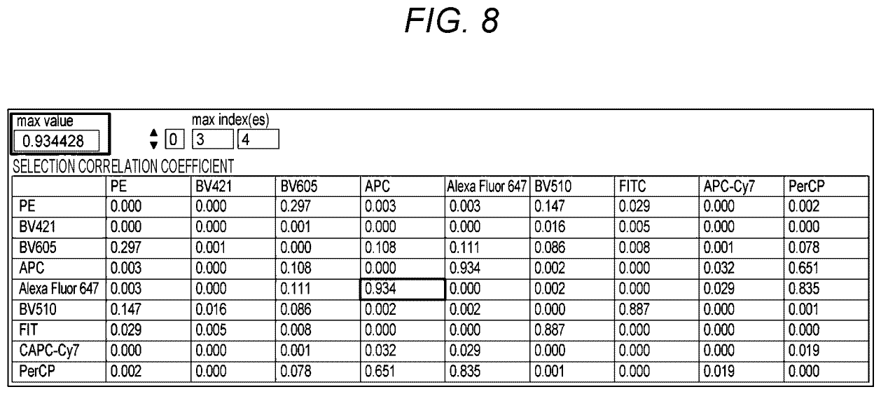

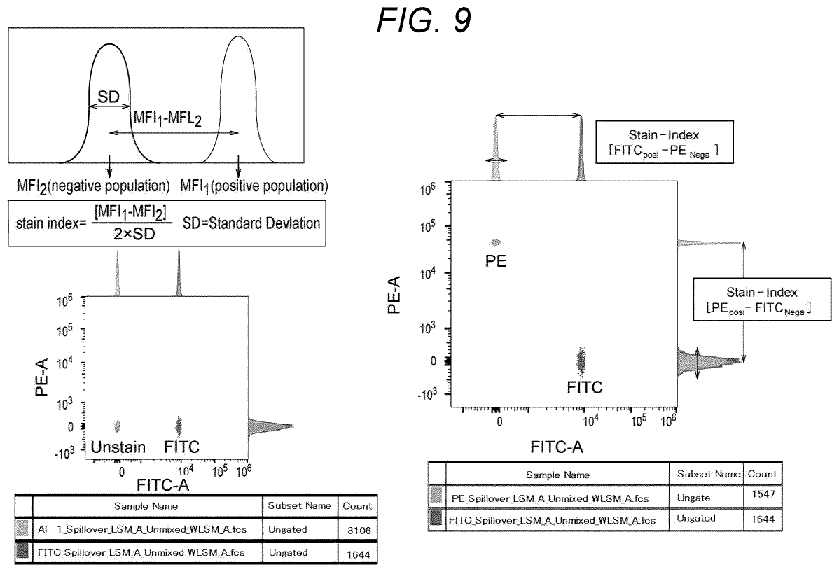

Next, the processing unit 101 calculates the square of the correlation coefficient (for example, Pearson correlation coefficient) between the fluorescence spectra for any two combinations of fluorophores included in the fluorophore combination candidate. The processing unit 101 calculates the square of the correlation coefficient for all combinations. Through the calculation processing, the processing unit 101 obtains a matrix of correlation coefficient square values as illustrated in FIG. 8, for example. Then, the processing unit 101 specifies the maximum correlation coefficient square value from the matrix of correlation coefficient square values. For example, in FIG. 8, the correlation coefficient between the fluorescence spectrum of Alexa Fluor 647 and the fluorescence spectrum of APC is 0.934, and the processing unit 101 specifies this value as the maximum correlation coefficient square value (a portion surrounded by a square in the upper left of the figure).

Note that the smaller the correlation coefficient square value is, the less similar the two fluorophore spectra are. That is, the two fluorophores having the maximum correlation coefficient square value can mean the two fluorophores having the most similar fluorescence spectra among the fluorophores included in the fluorophore combination candidate.

By the above processing, the processing unit 101 specifies the maximum correlation coefficient square value for one fluorophore combination candidate.

Here, in a case where the “number of fluorophores belonging to a certain brightness category” is larger than the “number of biomolecules belonging to an expression level category associated with the certain brightness category”, there is a plurality of combinations of fluorophores selected from the certain brightness category. For example, there are six kinds of fluorophore combinations (=₄C₂) in a case where two fluorophores are selected from four fluorophores. Therefore, for example, in a case where there are three brightness categories, four fluorophores belong to any of the three brightness categories, and two fluorophores are selected from each brightness category, there are 216 fluorophore combination candidates of 6×6×6.

In the present technology, the processing unit 101 specifies the maximum correlation coefficient square value as described above for all possible fluorophore combination candidates. For example, in a case where there are 216 fluorophore combination candidates, the processing unit 101 specifies the maximum correlation coefficient square value of each of the 216 fluorophore combination candidates. Then, the processing unit 101 specifies a fluorophore combination candidate having the smallest specified maximum correlation coefficient square value. The processing unit 101 specifies the fluorophore combination candidate specified in this manner as an optimal fluorophore combination.

c of FIG. 7A illustrates the specifying result of the optimal fluorophore combination. In c of FIG. 7A, the fluorophores constituting the specified optimal fluorophore combination are marked with stars.

Note that, in a case where there are two or more fluorophore combination candidates having the smallest maximum correlation coefficient square value, the processing unit 101 can compare the second largest correlation coefficient square value with respect to the two or more fluorophore combination candidates and specify a fluorophore combination candidate having the second largest correlation coefficient square value smaller as the optimal fluorophore combination. In a case where the second largest correlation coefficient square values are the same, the third largest correlation coefficient square values can be compared.

In the above description, the maximum correlation coefficient square value is referred to in order to specify the optimal fluorophore combination, but what is referred to in order to specify the optimal fluorophore combination is not limited thereto. For example, it may be an average value or a total value from the largest value to the nth (here, n may be any positive number, for example, 2 to 10, particularly 2 to 8, and more particularly 2 to 5) largest value among the correlation coefficient square values. The processing unit 101 may specify the fluorophore combination candidate having the smallest average value or the smallest total value as the optimal fluorophore combination.

In step S108, the processing unit 101 assigns the fluorophores constituting the optimal fluorophore combination specified in step S107 to the plurality of biomolecules. More specifically, the processing unit 101 assigns each of the fluorophores constituting the optimal fluorophore combination to the biomolecules belonging to the expression level category associated with the brightness category to which the fluorophore belongs.

The processing unit 101 generates a combination of a fluorophore and a biomolecule for each biomolecule by the assignment processing described above. In this manner, the processing unit 101 generates a combination list of fluorophores for biomolecules.

Here, in a case where two or more fluorophores are included in one brightness category, two or more biomolecules are also included in the associated expression level category. Therefore, there is a degree of freedom in the combination of fluorophores and biomolecules. For example, in a case where two fluorophores and biomolecules are included in each of the associated categories, there are two assignment patterns of fluorophores to biomolecules. Furthermore, in a case where three fluorophores and biomolecules are included in each of the associated categories, there are six assignment patterns of fluorophores to biomolecules. In this manner, there may be a plurality of combination lists that can be generated in step S108.

Therefore, the processing unit 101 evaluates the separation ability related to the combination list. On the basis of the result of the evaluation, the processing unit 101 can specify an optimal combination list from among the plurality of combination lists.

In a preferred embodiment, the processing unit 101 evaluates the separation ability related to the combination list by using the expression relationship information input in step S102. For example, the processing unit 101 can specify a fluorophore pair to be evaluated in the evaluation of the separation ability by using the expression relationship information. By performing the separation ability evaluation using the expression relationship information, it is possible to perform the separation ability evaluation limited to the fluorophore pair corresponding to the biomolecule pair to be analyzed.

Hereinafter, an example of the separation ability evaluation processing will be described.

In step S109, the processing unit 101 can evaluate the separation ability with respect to the combination list generated in step S108 by using the expression relationship information input in step S102. As an evaluation index for evaluating the separation ability, a separation performance index between fluorophores included in the combination list can be used. The evaluation index may be, for example, an inter-fluorophore stain index. In particular, the evaluation index may be an index calculated from data obtained by performing unmixing processing the simulation data. In the evaluation of the separation ability, the processing unit 101 may refer to a separation performance index (for example, an inter-fluorophore stain index) of the specified fluorophore pair.

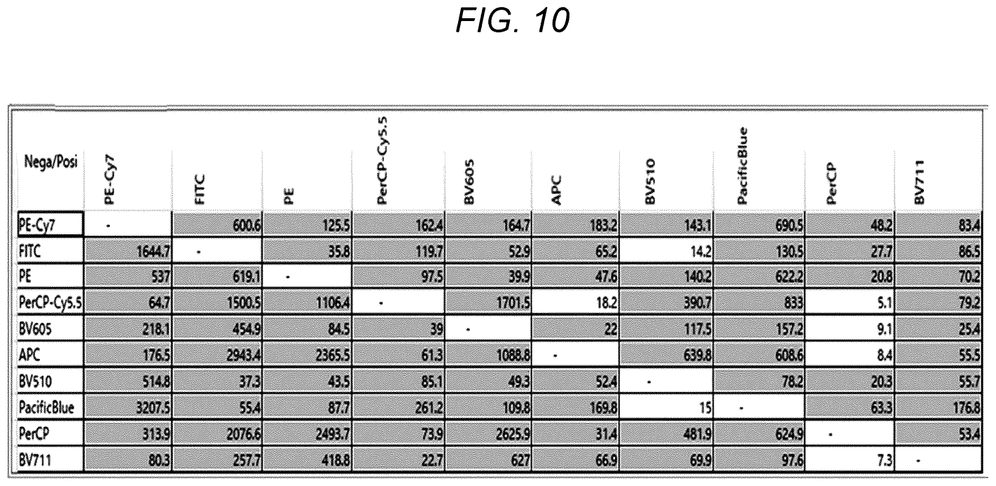

The inter-fluorophore stain index will be described below. First, in the art, the stain index is an index indicating the performance of a fluorophore (fluorescent dye) itself, and is defined by the amount of fluorescence of stained particles and unstained particles and the standard deviation of unstained particle data, for example, as illustrated in the left of FIG. 9. The unstained particle data replaced with particles stained with another fluorophore is the stain index between the fluorophores, for example, as illustrated in the right of FIG. 9. By the stain index between the fluorophores, it is possible to evaluate the separation performance between the fluorophores in consideration of the leakage amount due to the overlapping of the fluorescence spectra, the amount of fluorescence, and noise.

In the present specification, the inter-fluorophore stain index is also referred to as “inter-fluorophore SI”. Furthermore, the stain index is also referred to as “SI”.

Hereinafter, an example of the separation ability evaluation processing using the expression relationship information will be described.

The processing unit 101 calculates a separation performance index between two fluorophores in the fluorophore group included in the combination list generated in step S108. The separation performance index between the fluorophores may be calculated for all the fluorophore pairs in the fluorophore group included in the combination list.

The processing unit 101 can generate matrix data of the calculated separation performance indexes. An example of the matrix data is illustrated in FIG. 10. The matrix data includes the inter-fluorophore SI for all the fluorophore pairs in the fluorophore groups included in the combination list.

Here, a biomolecule is assigned to each fluorophore in the combination list. Therefore, the calculated separation performance index can be associated with a biomolecule pair corresponding to a fluorophore pair for which the separation performance index is to be calculated.

Furthermore, as described above, a biomolecule pair is specified on the basis of the expression relationship information. Therefore, it is possible to specify the fluorophore pair corresponding to the specified biomolecule pair, and further, it is possible to specify the separation performance index corresponding to the fluorophore pair. The fluorophore pair corresponding to the biomolecule pair may be particularly required to have good separation ability in analysis, for example.

As described above, on the basis of the expression relationship information, for example, it is possible to specify only the fluorophore pair required to have good separation ability in analysis, and it is possible to refer only to the separation performance index of the fluorophore pair in the separation ability evaluation.

That is, the processing unit 101 specifies a biomolecule pair using the expression relationship information, and then specifies a fluorophore pair corresponding to the biomolecule pair with reference to the combination list. Further, the processing unit 101 specifies the separation performance index of the specified fluorophore pair. The processing unit 101 can perform the separation ability evaluation on the basis of the specified separation performance index of the fluorophore pair.

In this case, the separation performance indexes of other fluorophore pairs may not be referred to in the separation ability evaluation. Alternatively, the separation performance indexes of other fluorophore pairs may be given a lower weight than the separation performance index of the specified fluorophore pair and used in the separation ability evaluation.

In this manner, according to the expression relationship information, the processing unit 101 can perform the separation ability evaluation of the combination list with emphasis on the separation performance index of the fluorophore pair corresponding to the biomolecule pair to be analyzed (for example, with reference to only the separation performance index of the fluorophore pair).

An example of specific processing by the processing unit 101 will be described below.

For example, in FIG. 7C, the specifying result of the biomolecule pairs based on the expression relationship information is illustrated as matrix data. In the matrix data, two biomolecules corresponding to the cell in which “TRUE” is displayed are two biomolecules constituting the specified biomolecule pair.

In the case of executing the separation ability evaluation using the specifying result illustrated in FIG. 7C, the processing unit 101 specifies two biomolecules (biomolecule pair) corresponding to the cell in which “TRUE” is displayed. Then, the processing unit 101 further refers to the combination list to specify two fluorophores assigned to the two biomolecules. Then, the processing unit 101 specifies the inter-fluorophore SI of the two fluorophores from the SI matrix illustrated in FIG. 10.

The processing unit 101 specifies the inter-fluorophore SIs as described above for two biomolecules corresponding to all the cells in which “TRUE” is displayed.

The inter-fluorophore SI specified as described above is used in the separation ability evaluation.

In this manner, the processing unit 101 specifies the inter-fluorophore SIs used in the separation ability evaluation from among all the inter-fluorophore SIs illustrated in FIG. 10 using the expression relationship information. The unspecified inter-fluorophore SIs may not be used in the separation ability evaluation, or may be used in the separation ability evaluation with a lower weight compared to the specified inter-fluorophore SIs.

Then, the processing unit 101 specifies a minimum value from the specified inter-fluorophore SIs, for example. The processing unit 101 can use the minimum value as an evaluation value for evaluating the separation ability of the combination list generated in step S108.

Note that the value used as the evaluation value is not limited to the minimum value. For example, among the specified inter-fluorophore SIs, a predetermined number (for example, two to five) of smallest fluorophore SIs including the minimum value may be used as the evaluation value. For example, an average value of the predetermined number of inter-fluorophore SIs and the like can be used as the evaluation value. Furthermore, for example, the unspecified inter-fluorophore SIs may be given a lower weight than the specified inter-fluorophore SI and used in the calculation of the average value or the like.

As described above, in the present technology, a fluorophore pair to be evaluated in the evaluation of the separation ability can be specified using the expression relationship information. By using the expression relationship information, it is possible to perform the separation ability evaluation focusing on the biomolecule expressed by the bioparticle (in particular, the cell) to be analyzed, and it is possible to select a more appropriate combination list. Moreover, since the processing related to the separation ability evaluation is performed by focusing on the biomolecule expressed by the bioparticle to be analyzed by the user, the separation ability evaluation processing can be made efficient and/or fast.

The separation performance index used in the present technology may be the inter-fluorophore SI as described above. The separation performance index can be acquired using, for example, simulation data generated on the basis of the combination list. The simulation data may be, for example, a data group as if measured by a device (for example, a flow cytometer) on which analysis using reagents according to a combination list is performed. In a case where the device is a microparticle analyzer such as a flow cytometer, for example, the simulation data may be a data group obtained in a case where 100 to 1000 microparticles are actually measured. For example, the simulation data can be generated based on information regarding the fluorophores included in the combination list, the expected expression levels of biomolecules, and device noise information. For the generation of the data group, for example, conditions such as staining variation and the number of generated data may be considered.

Note that, in the separation ability evaluation processing described above, the separation performance index is first calculated, and then the separation performance index referred to in the separation ability evaluation is extracted using the expression relationship information. In the present technology, first, the fluorophore pair referred to in the separation ability evaluation may be specified using the expression relationship information, and then the inter-fluorophore separation performance index may be calculated for the specified fluorophore pair. That is, in one embodiment of the present technology, the processing unit 101 can specify the target for which the evaluation index used in the evaluation of the separation ability is calculated using the expression relationship information.

For example, in analysis such as flow cytometry, usually, the evaluation index is only required to be calculated only for some fluorophore pairs among all selectable fluorophore pairs among a plurality of fluorophores included in the combination list. For example, a combination of fluorophores for which the generation of a scattergram, such as a two-dimensional plot, is sought is typically a subset of all fluorophore pairs. Therefore, it is possible to improve the efficiency and speed of the evaluation processing by calculating the evaluation index only for some fluorophore pairs instead of calculating the evaluation index for all the fluorophore pairs.

As described above, by using the expression relationship information, it is possible to perform the separation ability evaluation focusing on the biomolecule expressed by the bioparticle (in particular, the cell) to be analyzed by the user, and it is possible to select a more appropriate combination list.

In step S110, the processing unit 101 executes the separation ability evaluation processing for other adoptable combination lists in the same manner as in step S109. For example, as described above, the processing unit 101 acquires the evaluation value for each combination list.

An example of processing by the processing unit 101 in step S110 will be described with reference to FIG. 11.

Suppose that the combination list of the fluorophores and the biomolecules as illustrated in FIG. 11A is generated in step S108, and then the inter-fluorophore SIs as illustrated in FIG. 11A are calculated in step S109. Note that the biomolecule names illustrated in FIG. 11 are added for convenience to describe step S110, and are different from the biomolecule names illustrated in FIG. 7A.

Here, the fluorophores belonging to the brightness category of Normal are four of APC, Alexa Fluor, BV510, and FITC, and the biomolecules belonging to the expression level category associated with the brightness category are also four of CD4 to CD7. Therefore, there is a plurality of combinations of the four fluorophores and the four biomolecules other than the combination illustrated in FIG. 11A, and there are 24 patterns in total. Similarly, regarding the brightness categories of Bright and Dim and the expression level categories associated with them, there is a plurality of assignment patterns. Therefore, in step S108, the processing unit 101 can perform the separation ability evaluation for all the other adoptable combination lists satisfying the condition that the association between the brightness categories and the expression level categories is not deviated, similarly to the one illustrated in FIG. 11A.

For example, in the combination list illustrated in FIG. 11A, the fluorescent dye APC belonging to the brightness category of Normal is assigned to the biomolecule CD4 belonging to the expression level category associated with the brightness category. The fluorescent dye Alexa Fluor belonging to the brightness category is assigned to the biomolecule CD5 belonging to the expression level category. Therefore, the processing unit 101 generates the combination list illustrated in FIG. 11A as one of the other combination lists, for example, except that APC is assigned to CD5 and Alexa Fluor is assigned to CD4. The combination list is illustrated in FIG. 11B. In this manner, for all the combination lists in which the way of assigning the fluorescent dyes to the biomolecules is changed within the brightness categories and the expression level categories associated with each other, in step S110, the processing unit 101 executes the separation ability evaluation. Therefore, the processing unit 101 acquires evaluation values for all the combination lists.

As described above, in the present technology, the processing unit 101 can evaluate the separation ability using the expression relationship information for all combination lists that can be generated on the basis of the expression level categories and the brightness categories.

In step S111, the processing unit 101 specifies an optimized combination list on the basis of the results of the separation ability evaluation in steps S109 and 110.

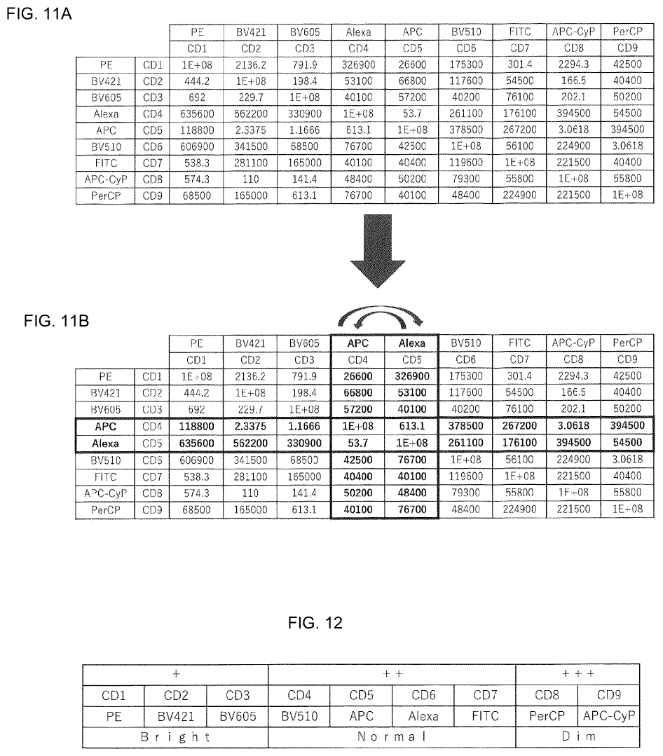

For example, the processing unit 101 specifies a maximum evaluation value from the evaluation values acquired in steps S109 and 110, and then specifies a combination list in which the maximum evaluation value has been acquired. The processing unit 101 specifies the combination list from which the maximum evaluation value has been acquired as an optimized combination list. An example of an optimized combination list is illustrated in FIG. 12.

Note that the present technology also provides an information processing apparatus including a processing unit that executes the separation ability evaluation described above. That is, the present technology also provides an information processing apparatus including a processing unit that executes evaluation of separation ability regarding a combination list of fluorophores for a biomolecule in which a fluorophore is assigned to a plurality of biomolecules used for analysis of a sample, in which the processing unit evaluates separation ability regarding the combination list using expression relationship information of the plurality of biomolecules.

In step S112, the processing unit 101 can cause, for example, the output unit 104 to output the optimization combination list specified in step S111 to the output unit. For example, the combination list can be displayed on the display device.

In step S112, the processing unit 101 can further display reagent information corresponding to the combination of the antibodies (or antigens) and the fluorescent dyes on the output unit 104. The reagent information may include, for example, names of reagents, product numbers, manufacturer names, prices, and the like. In order to display the reagent information, for example, the processing unit 101 may acquire the reagent information from a database existing outside the information processing apparatus 100 or from a database stored inside the information processing apparatus 100 (for example, the storage unit 102).

FIG. 7D illustrates an example of the output result. In this example, simulation results are also illustrated in addition to the names of the antibodies (or antigens), the names of the fluorescent dyes, the names of the reagents, the product numbers, the names of the manufacturers, the prices, and the like.

Preferably, in step S112, the processing unit 101 may further generate a simulation result (for example, various plots) regarding the separation ability in a case where the specified optimization combination list is used, and display the simulation result on the output unit. In the generation of the simulation result, for example, noise and/or sample variation of a bioparticle analyzer (flow cytometer or the like) may be considered. The processing unit 101 may further display separation performance expected in a case where the generated combination list is used.

In order to generate the simulation result, simulation data (hereinafter, also referred to as “single staining simulation data”) regarding a single stained bioparticle labeled with only one fluorophore among the fluorophores included in the optimization combination list may be used, simulation data (hereinafter, “multiple staining simulation data”) regarding a bioparticle labeled with a plurality of fluorophores according to the expression relationship information (particularly, expression relationship information having a tree structure) may be used, or both of these simulation data may be used.

That is, in a preferred embodiment of the present technology, the simulation result generated in step S112 may include a simulation result generated using the single staining simulation data and a simulation result generated using the multiple staining simulation data, and more preferably includes both of these simulation results. By such a simulation result, in particular, by the latter simulation result, a predicted distribution closer to the actual experimental result can be known.

By the above processing, the combination of the biomolecules and the fluorophores can be optimized, and the optimized combination list can be presented to the user.

### (3-3) Example of Processing by Processing Unit (Adjustment Processing of Fluorophore Combination)

In the processing described in (3-2) above, in step S107, a combination of fluorophores is specified on the basis of correlation information. Then, in and after step S108, each fluorophore in the specified fluorophore combination is assigned to each biomolecule. In step S107, since the specified fluorophore combination is based on the correlation information, there may be a case where the fluorophore combination does not completely match separation performance required in an analyzer such as a flow cytometer. Therefore, in the present technology, the processing unit may perform fluorophore combination adjustment processing for searching for a better fluorophore combination. For the search, for example, separation ability evaluation using inter-fluorophore SI can be performed.

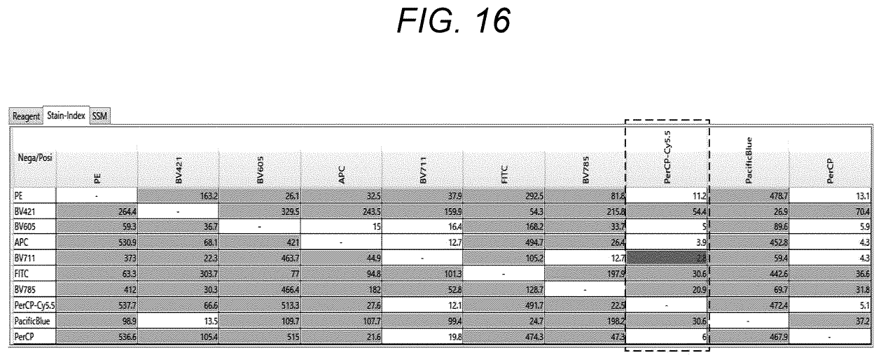

A larger inter-fluorophore SI is more preferable. For example, in the table of the inter-fluorophore SIs as illustrated in FIG. 16, the fewer the regions with small numerical values of inter-fluorophore SI, the better the separation performance of the fluorophore combination. Therefore, the adjustment processing may be, for example, processing of reducing the region where the numerical value of the inter-fluorophore SI is small. By such an adjustment processing, a panel having better separation performance can be designed.

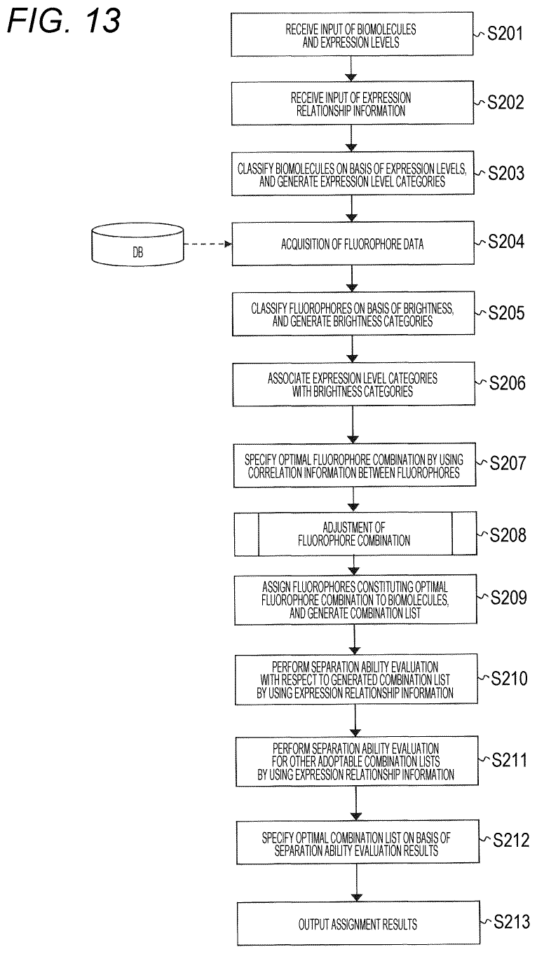

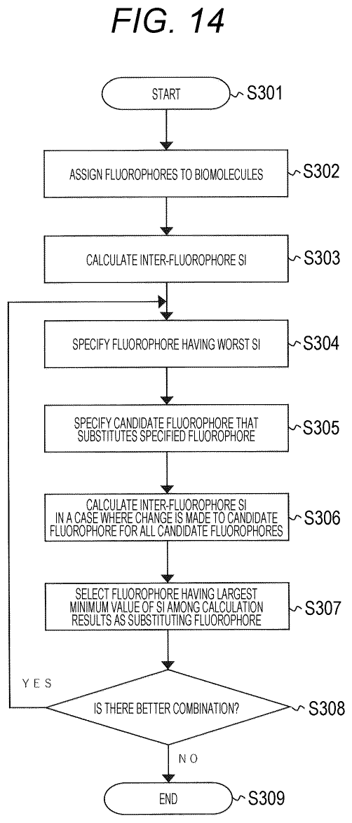

An example of processing by the information processing apparatus of the present technology that executes the adjustment processing will be described below with reference to FIGS. 13 and 14. FIGS. 13 and 14 are examples of a flowchart of the processing.

In the processing flow illustrated in FIG. 14, steps S201 to S207 and S209 to S215 are the same as steps S101 to S107 and S108 to 112 described with reference to FIG. 6, and the description thereof also applies to steps S201 to S207 and S209 to S213.

In step S208, the processing unit 101 performs adjustment processing of the fluorophore combination specified in step S207. An example of a more detailed processing flow of step S208 will be described with reference to FIG. 14.

In step S301 of FIG. 14, the processing unit 101 starts the adjustment processing.

In step S302, the processing unit 101 assigns the fluorophores constituting the optimal fluorophore combination specified in step S207 to the plurality of biomolecules. More specifically, the processing unit 101 assigns each of the fluorophores constituting the optimal fluorophore combination to the biomolecules belonging to the expression level category associated with the brightness category to which the fluorophore belongs.

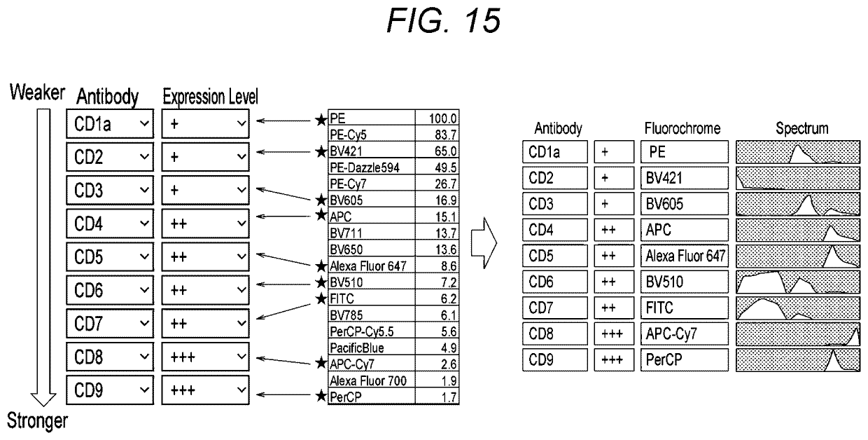

In a case where two or more fluorophores are included in one brightness category, two or more biomolecules can be included in the associated expression level category. In this case, a fluorophore having a brighter brightness may be assigned to a biomolecule having a lower expression level (or expected to have a lower expression level). FIG. 15 illustrates a conceptual diagram related to such assignment. By the assignment processing, a combination of the fluorophore and the biomolecule is generated for each biomolecule. In this manner, the processing unit 101 generates a combination list of fluorophores for biomolecules.

In step S303, the processing unit 101 calculates the inter-fluorophore SI. The SI can be obtained using, for example, data obtained by generating simulation data using the combination list generated in step S302 and performing unmixing processing on the simulation data using spectral reference. The simulation data may be as described above in (3-2).

In step S303, the processing unit 101 can acquire data of the inter-fluorophore SI as illustrated in FIG. 16, for example. The data includes all SIs between two different fluorophores in the fluorophore group constituting the combination list.

In step S304, the processing unit 101 specifies one or a plurality of fluorophores having poor separation performance, particularly one fluorophore having poor separation performance, on the basis of the calculated inter-fluorophore SIs. For example, the processing unit 101 can specify a fluorophore treated as positive among two fluorophores for which the smallest inter-fluorophore SI is calculated as one fluorophore having poor separation performance.

For example, with respect to the inter-fluorophore SI data illustrated in FIG. 16, in step S304, the processing unit 101 specifies the fluorophore “PerCP-Cy5.5” treated as positive (posi) among the two fluorophores for which the smallest inter-fluorophore SI “2.8” is calculated as one fluorophore having poor separation performance.

In step S305, the processing unit 101 specifies a candidate fluorophore that substitutes the fluorophore having poor separation performance specified in step S304. The candidate fluorophores may be specified, for example, as follows. First, the processing unit 101 may refer to a brightness category to which the fluorophore having poor separation performance belongs, and specify a fluorophore not adopted in the combination list among fluorophores belonging to the brightness category as a candidate fluorophore. In addition, the processing unit 101 may select the candidate fluorophore from the brightness category having the closest brightness to the brightness category to which the fluorophore having poor separation performance belongs. The processing unit 101 can specify a fluorophore not adopted in the combination list among fluorophores belonging to the closest brightness category as a candidate fluorophore.

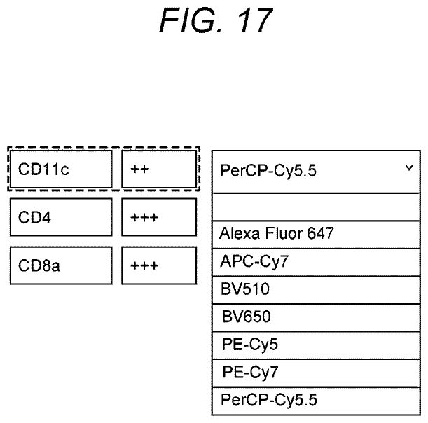

For example, in FIG. 17, the processing unit 101 specifies six fluorophores such as “Alexa Fluor 647” as candidate fluorophores to substitute the fluorophore “PerCP-Cy5.5” having poor separation performance. In this manner, a plurality of candidate fluorophores may be specified, or only one candidate fluorophore may be specified.

In step S306, the processing unit 101 calculates inter-fluorophore SI in a case where the fluorophore having poor separation performance specified in step S305 is changed to a candidate fluorophore. This calculation may be performed for all of the candidate fluorophores, respectively.

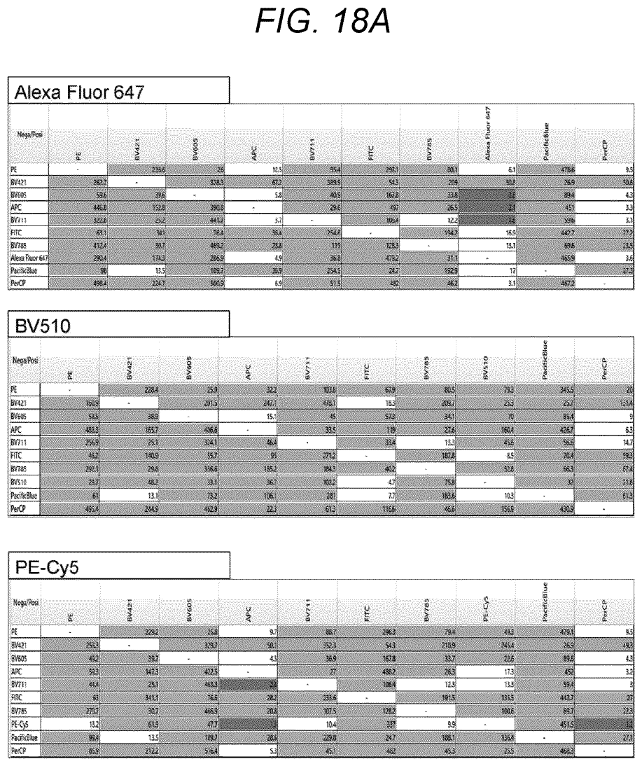

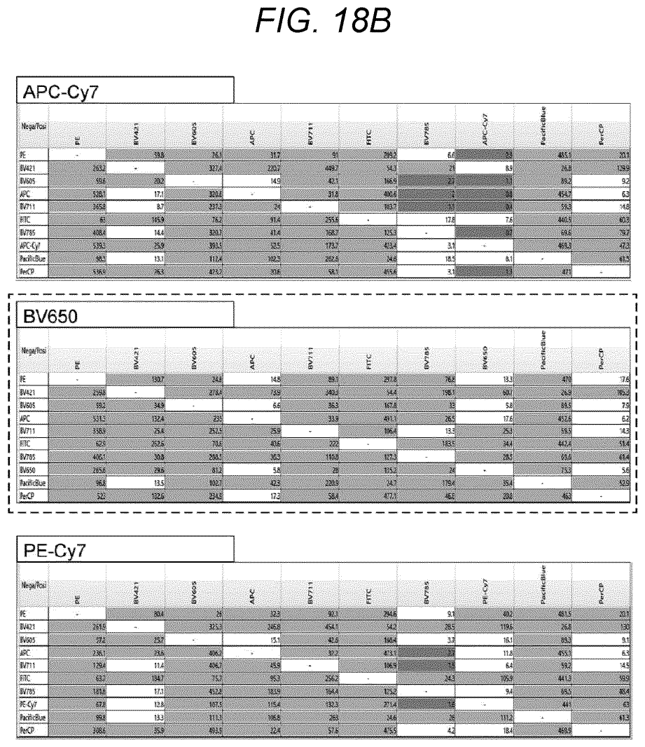

An example of the calculation result is illustrated in FIGS. 18A and 18B. In FIGS. 18A and 18B, for each of the six fluorophores mentioned with reference to FIG. 17, the inter-fluorophore SI in a case where the fluorophore having poor separation performance is changed to the candidate fluorophore is illustrated.

In step S307, the processing unit 101 selects, as a fluorophore substituting for the fluorophore having poor separation performance, a candidate fluorophore for which a calculation result having the largest minimum value of the inter-fluorophore SI has obtained among the calculation results in step S306.

For example, regarding the calculation results in FIGS. 18A and 18B, the minimum value of the inter-fluorophore SI related to “BV650” is the largest among the minimum values of the inter-fluorophore SIs in the calculation results of the six candidate fluorophores. Therefore, the processing unit 101 selects “BV650” as a fluorophore substituting “PerCP-Cy5.5”.

In step S308, the processing unit 101 determines whether there is a fluorophore combination that is better than the fluorophore combination obtained by substituting the fluorophore having poor separation performance with the fluorophore selected in step S307. For this determination, for example, step S304 to 307 may be repeated.

In a case where there is a combination in which the minimum value of the inter-fluorophore SI becomes larger as a result of repeating step S304 to 307, the processing unit 101 determines that there is a better fluorophore combination. In a case where the determination is made in this manner, the processing unit 101 returns the processing to step S304.

In a case where there is no combination in which the minimum value of the inter-fluorophore SI becomes larger as a result of repeating step S304 to 307, the processing unit 101 determines that there is no better fluorophore combination. In a case where it is determined that there is no better fluorophore combination, the processing unit 101 specifies a fluorophore combination in a stage immediately before repeating step S304 to 307 as an optimized combination list, and advances the processing to step S309.

In step S309, the processing unit 101 ends the separation ability evaluation processing and advances the processing to step S209.

By the above processing, it is possible to specify a fluorophore combination that exhibits better separation performance.

### (3-4) Example of Processing by Processing Unit (Input of Axis Information)

When an experiment is performed by a flow cytometer, an analysis procedure for obtaining a distribution ratio of cells to be analyzed (for example, a gating procedure as described above with reference to FIG. 3) is often constructed to some extent. Therefore, a biomolecule to be adopted as an axis in the analysis result (for example, scattergram) is also assumed to some extent, and good separation ability is required in a combination of fluorophores labeling the biomolecule. In the information processing in the present technology, information regarding a biomolecule assumed to be adopted as an axis in this manner may be used.

That is, in one embodiment of the present technology, combination information regarding combinations of biomolecules to be output may be used in processing of generating a combination list of fluorophores for biomolecules. For example, in the present technology, the processing unit can further use combination information related to a combination of biomolecules to be output in specifying an evaluation target in the evaluation of separation ability.

In specifying the evaluation target, it is possible to optimize only a portion in which the separation performance is required by the user by using the combination information in addition to the expression relationship information. Therefore, it is possible to obtain a better panel.

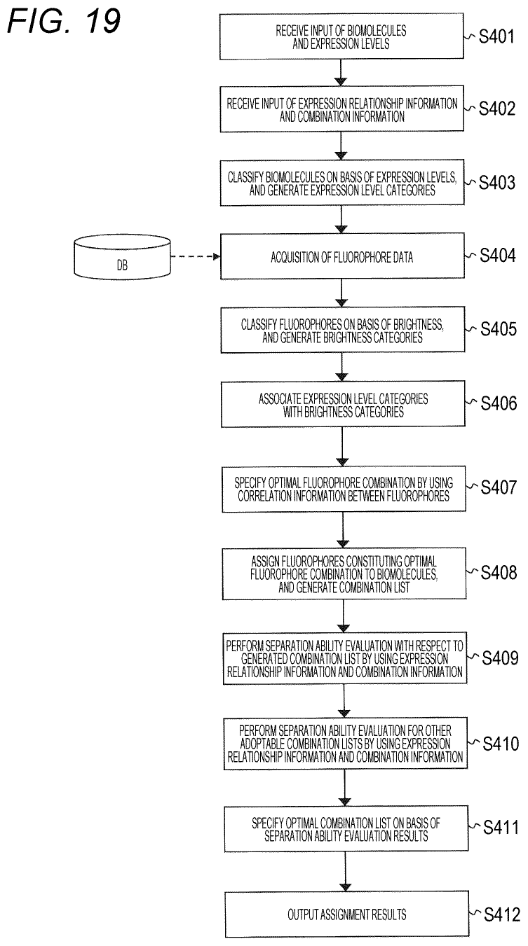

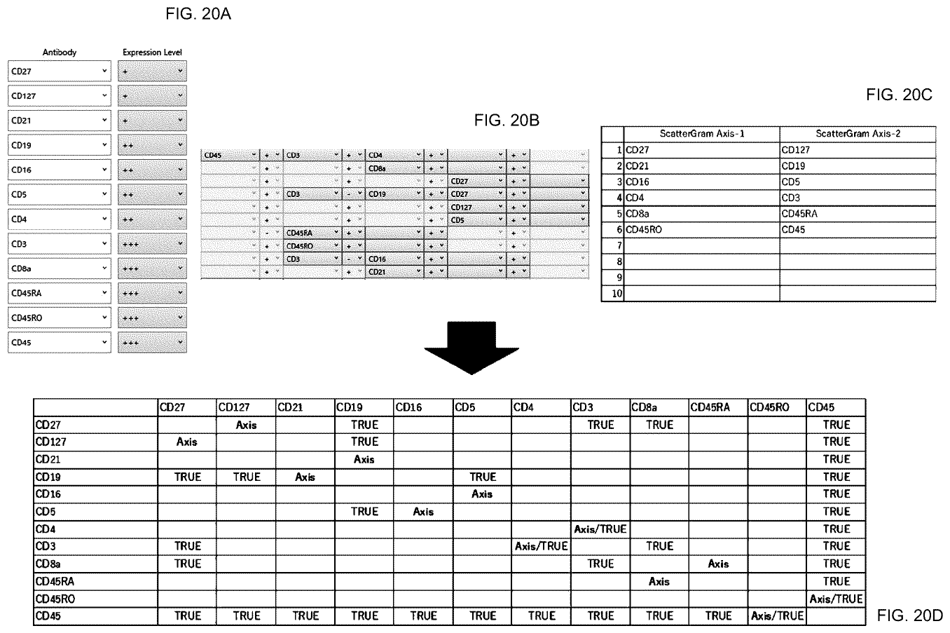

Hereinafter, this embodiment will be described with reference to FIGS. 19 and 20. FIG. 19 is a flowchart of processing executed by the information processing apparatus. FIG. 20 is a diagram for explaining how to specify the evaluation target based on the expression relationship information and the combination information.

In the processing flow illustrated in FIG. 19, steps S401, S403 to S408, and S412 are the same as steps S101, S103 to S108, and S112 described in (3-2) above, and the description thereof also applies to steps S401, S403 to S408, and S412.

In step S402, the processing unit 101 receives an input of expression relationship information and combination information. Regarding the reception processing of the expression relationship information and the input thereof, the description of step S102 in the above (3-2) also applies to step S402.

In step S402, the processing unit 101 receives an input of combination information regarding a combination of biomolecules to be output. The combination of biomolecules to be output may be a combination of any two biomolecules among the plurality of biomolecules input in step S401. The number of combinations of biomolecules included in the combination information may be appropriately selected by the user, and for example, may be appropriately set according to the number of scattergrams that the user desires to output. The number of the combinations may be, for example, one or more, two or more, or three or more. Furthermore, the number of the combinations may be, for example, 100 or less, 50 or less, or 30 or less.

An example of a window displayed to receive the input in steps S401 and S402 is illustrated in A to C of FIG. 20. A of FIG. 20 is an example of a window that receives the input of the biomolecules and the expression levels in step S401, and B of FIG. 20 is an example of a window that receives the input of the expression relationship information in step S402. These windows are as described above in (3-2).

C of FIG. 20 is an example of a window that receives the input of the combination information in step S402. Each row in the window corresponds to each combination included in the combination information. Each column of the window (“Axis 1” and “Axis 2”) corresponds to a respective biomolecule of the two axes of the output scattergram. For example, “CD27” and “CD127” are selected in “Axis 1” and “Axis 2”, respectively, as illustrated in the first row of C of FIG. 20, to have two axes of one scattergram as “CD27” and “CD127”, respectively. It similarly applies to the other rows.

The input operation of the combination information is, for example, as follows.

The user clicks the biomolecule selection field in each row. In response to the click, the processing unit 101 displays a list box of a list of selectable biomolecules. In response to the user selecting one biomolecule from the list, the list box is closed and the selected biomolecule is displayed. The list of selectable biomolecules may include, for example, a plurality of biomolecules selected in step S401, and only the plurality of biomolecules may be displayed.

As described above, the two biomolecules constituting each combination included in the combination information are specified.

In step S409, the processing unit 101 can evaluate the separation ability with respect to the combination list generated in step S402 using the expression relationship information and the combination information input in step S408.

In the separation ability evaluation processing, as described in (3-2) above, the processing unit 101 calculates the inter-fluorophore SIs for all the fluorophore pairs in the fluorophore group included in the combination list.

Next, the processing unit 101 specifies a fluorophore pair to be evaluated in the evaluation of separation ability by using the expression relationship information and the combination information.

The specification of the fluorophore pair using the expression relationship information may be performed as described in (3-2) above. Therefore, the fluorophore pair corresponding to the biomolecule pair included in the expression relationship information is specified.

The specification of the fluorophore pair using the combination information is performed, for example, as follows. As described above, each row of the combination information specifies a combination of two biomolecules to be output. Therefore, the processing unit 101 specifies two biomolecules constituting the combination. The processing unit 101 specifies a fluorophore pair corresponding to the combination.

D of FIG. 20 illustrates the specifying result of the biomolecule pairs based on the expression relationship information and the combination information as matrix data. In the matrix data, two biomolecules corresponding to the cells in which “TRUE” is displayed are two biomolecules constituting the biomolecule pair specified using the expression relationship information. Furthermore, in the matrix data, two biomolecules corresponding to the cell in which “Axis” is displayed are two biomolecules constituting the biomolecule pair specified using the combination information.

In a case where the processing unit 101 executes the separation ability evaluation using the specifying result illustrated in D of FIG. 20, the processing unit 101 specifies two biomolecules (biomolecule pair) corresponding to the cell in which “TRUE” and/or “Axis” is displayed. Then, the processing unit 101 further refers to the combination list to specify two fluorophores assigned to the two biomolecules. Then, the processing unit 101 specifies the inter-fluorophore SI of the two fluorophores from the SI matrix as illustrated in FIG. 10, for example.

The processing unit 101 specifies the inter-fluorophore SI as described above for two biomolecules corresponding to all the cells in which “TRUE” and/or “Axis” are/is displayed.

The inter-fluorophore SI specified as described above is used in the separation ability evaluation.

Note that, in the separation ability evaluation, depending on whether the biomolecule pair is specified by the expression relationship information, the combination information, or both of these pieces of information, the separation performance index of the fluorophore pair corresponding to the biomolecule pair may be weighted and used in the separation ability evaluation. For example, in specifying or calculating the evaluation value, a weight may be assigned to the separation performance index corresponding to the biomolecule pair depending on how the biomolecule pair is specified.

The specification of the evaluation value among the specified inter-fluorophore SI may be performed as described in (3-2) above.

By using the expression relationship information and the combination information as described above, it is possible to perform the separation ability evaluation focusing on the biomolecule expressed by the bioparticle (in particular, the cell) to be analyzed and the biomolecule to be output by the user, and it is possible to select a more appropriate combination list. Furthermore, since the processing related to the separation ability evaluation is performed by focusing on the biomolecule expressed by the bioparticle to be analyzed by the user, the separation ability evaluation processing can be made efficient and/or fast.

In step S410, the processing unit 101 executes the separation ability evaluation processing using the expression relationship information and the combination information for other adoptable combination lists in the same manner as in step S409. For example, as described above, the processing unit 101 acquires the evaluation value for each combination list.

In step S411, an optimal combination list is specified on the basis of the separation ability evaluation results in steps S409 and S410. Then, in step 412, an output is performed.

By the processing as described above, it is possible to perform panel optimization focusing on biomolecules to be output by the user.

### (3-5) Example of Processing by Processing Unit (Input of Expression Relationship Information Based on Expected Analysis Result)

For example, a user who uses a device such as a flow cytometer may be accustomed to the gating operation, but may not be accustomed to the input operation of the expression relationship information and/or the combination information described in (3-2) and (3-4) above. Therefore, if the expression relationship information and/or the combination information can be input as performing the gating operation, it is considered that the convenience for the user is improved.

In a preferred embodiment of the present technology, the expression relationship information and/or the combination information may include data extracted from measurement result data assumed to be acquired. In this embodiment, the processing unit 101 can execute an output step of causing an output device to output a screen that receives an input of information for generating measurement result data (hereinafter also referred to as “assumed measurement result data”) that is assumed to be acquired. Then, the processing unit 101 can execute an extraction step of extracting expression relationship information and/or combination information from the assumed measurement result data input via the screen. In this embodiment, the user can input the expression relationship information and/or the combination information as if the gating operation is performed, and convenience for the user is improved.

In this embodiment, the assumed measurement result data may be, for example, measurement result data considered to be acquired by analysis of the sample, and the assumed measurement result data may be appropriately created by the user. The assumed measurement result data includes, for example, a schematic diagram of one or a plurality of assumed scattergrams, and particularly includes a schematic diagram of a plurality of assumed scattergrams.

The schematic diagram of each scattergram may be a scattergram schematic diagram in which any two of the plurality of biomolecules are adopted as axes. The distribution of the bioparticle in the schematic diagram of each scattergram may be represented by an arbitrary figure. The figure may be, for example, a circle (including a perfect circle and an ellipse), a rectangle, or another polygon, or may be a region having a shape other than these.

The output step and the extraction step in this embodiment can be performed, for example, in step S102 described in the above (3-2) or step S402 described in the above (3-4).

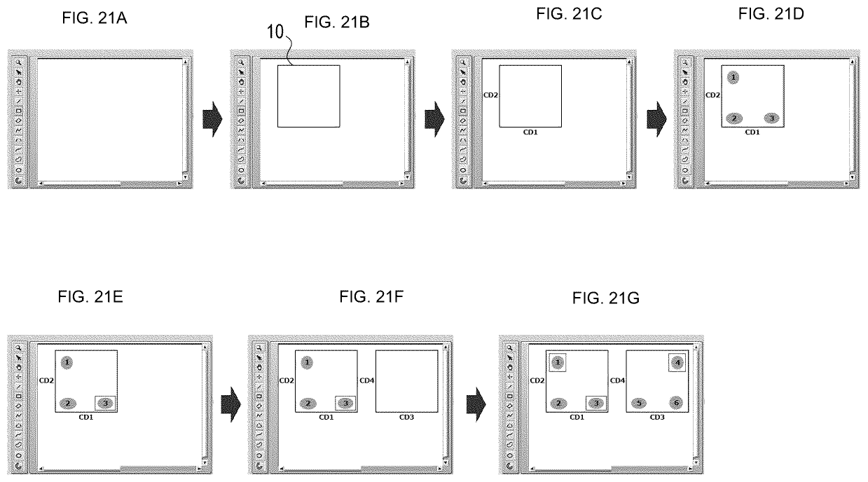

An example of a case where the output step and the extraction step are performed in step S402 will be described below with reference to FIG. 21. FIG. 21 is an example of a screen for receiving input of information for generating assumed measurement result data.

In step S402, the processing unit 101 can cause the output unit to output, for example, a window as illustrated in A of FIG. 21 as a screen for receiving input of measurement result data assumed to be acquired. A drawing tool bar for inputting an assumed scattergram schematic diagram is displayed on the left side of the window.

Next, in response to the user clicking a scattergram addition button (not illustrated), as illustrated in B of FIG. 21, the processing unit 101 displays a frame 10 on which the scattergram schematic diagram is written in the window.

Next, in response to a click of the frame 10 by the user, for example, the processing unit 101 displays a window (not illustrated) prompting the user to select a biomolecule to be adopted as an axis of the scattergram schematic diagram. In the window, in response to the user selecting biomolecules to be adopted as the X axis and the Y axis of the scattergram, the biomolecule names or abbreviations thereof are displayed in the vicinity of the frame (particularly, in the vicinity of the X axis and the Y axis) as illustrated in C of FIG. 21. In C of FIG. 21, “CD1” and “CD2” are displayed as the selected biomolecules as the X-axis and Y-axis biomolecules.

Next, the user draws a figure indicating a particle distribution assumed on the scattergram of the bioparticle characterized by the presence or absence of expression of the selected biomolecules in the frame 10 using, for example, a drawing tool bar. For example, the user operates the circle drawing tool so that circles 1, 2, and 3 are drawn as illustrated in D of FIG. 21. In response to the operation, the processing unit 101 displays the circles 1, 2, and 3 in the frame 10.

In circle 1, for example, it is assumed that a CD2-positive and CD1-negative cell population is distributed. In circle 2, for example, it is assumed that a CD2-negative and CD1-negative cell population is distributed. In circle 3, for example, it is assumed that a CD2-negative and CD1-positive cell population is distributed.

In this manner, the window may be configured to be able to receive an input of a figure indicating the bioparticle distribution assumed in the scattergram. The processing unit 101 displays the figure in the window according to the input operation of the figure indicating the assumed bioparticle distribution.

Next, the user draws a figure for setting the gate in the frame 10 using, for example, the drawing tool bar with respect to the circle in which the cell population to be developed is assumed. For example, in order to perform gate setting and development on the bioparticle belonging to the circle 3, the user operates the rectangle drawing tool so that a rectangle surrounding the circle 3 is drawn as illustrated in E of FIG. 21. In response to the operation, the processing unit 101 displays a rectangle surrounding the circle 3 in the frame 10.

In this manner, the window may be configured to be able to receive an input of a figure for setting and/or developing the gate with respect to the figure indicating the bioparticle distribution. The processing unit 101 displays the figure in the window according to an input operation of the figure for setting and/or developing the gate.

Next, the user selects the gate set by the rectangle, and then clicks a scattergram addition button (not illustrated) in a state where the gate is selected. In response to the click, as illustrated in F of FIG. 21, the processing unit 101 displays a frame of a scattergram schematic diagram in which the gate is developed in the window.

Furthermore, biomolecules to be adopted as axes in the developed scattergram schematic diagram can be selected by the user. The selection of the biomolecules may be performed as described with reference to C of FIG. 21. For example, in F of FIG. 21, “CD3” and “CD4” are displayed as the selected biomolecules as the biomolecules on the X-axis and the Y-axis. That is, CD3 and CD4 are selected as biomolecules to be adopted as axes of the scattergram schematic diagram generated by development of the gate.

Next, as illustrated in F of FIG. 21, the user operates the circle drawing tool so that circles 4, 5, and 6 are drawn. The operation may be performed as described above with reference to D of FIG. 21.

Furthermore, as illustrated in F of FIG. 21, a figure for setting a gate for the circle 4 is drawn. The operation for drawing the figure may be performed as described above with reference to E of FIG. 21.

Thereafter, the operation for setting and developing the gate described above can be appropriately repeated by the user according to the analysis target.

After the gate setting and development to the window are completed, the user selects a figure (for example, a circle) to which the bioparticle population from which the expression relationship information is extracted belongs. For example, in response to the user selecting any circle by, for example, mouse click or the like, the processing unit 101 extracts a plurality of biomolecules associated with the circle and the presence or absence of expression thereof. The processing unit 101 handles the information extracted in this way as expression relationship information.

For example, the processing unit 101 specifies all the figures used in the gating operation for forming the selected circle, refers to the axes of the scattergram schematic diagram in which each of all the figures is formed, and acquires information on the type and presence or absence of expression of the biomolecules for specifying the bioparticles corresponding to the circle. The processing unit 101 handles the acquired information as expression relationship information.

Furthermore, after the gate setting and the development to the window are completed, in order to acquire the combination information, the processing unit 101 acquires two biomolecules adopted as axes of all the generated scattergram schematic diagrams as a biomolecule pair constituting the combination information.

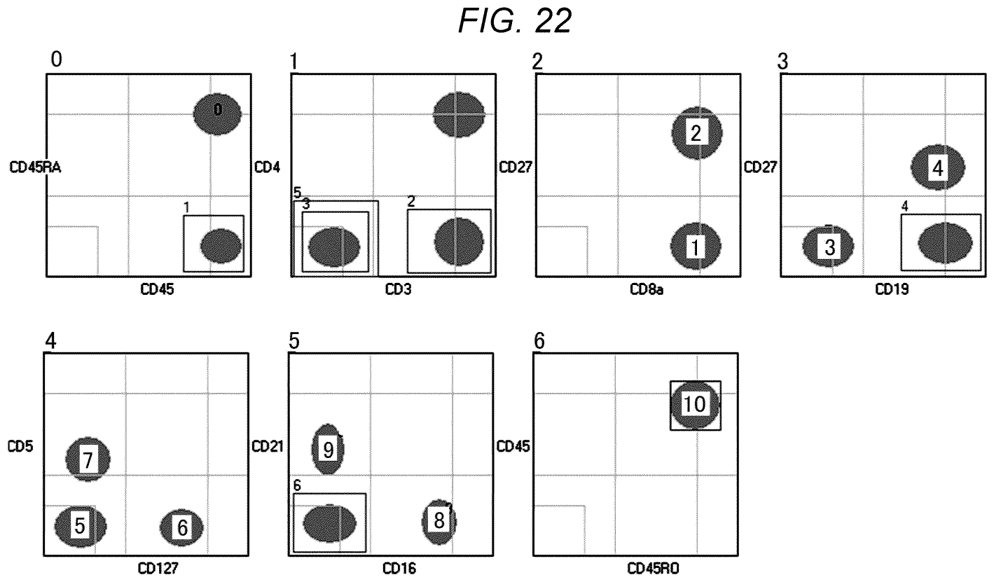

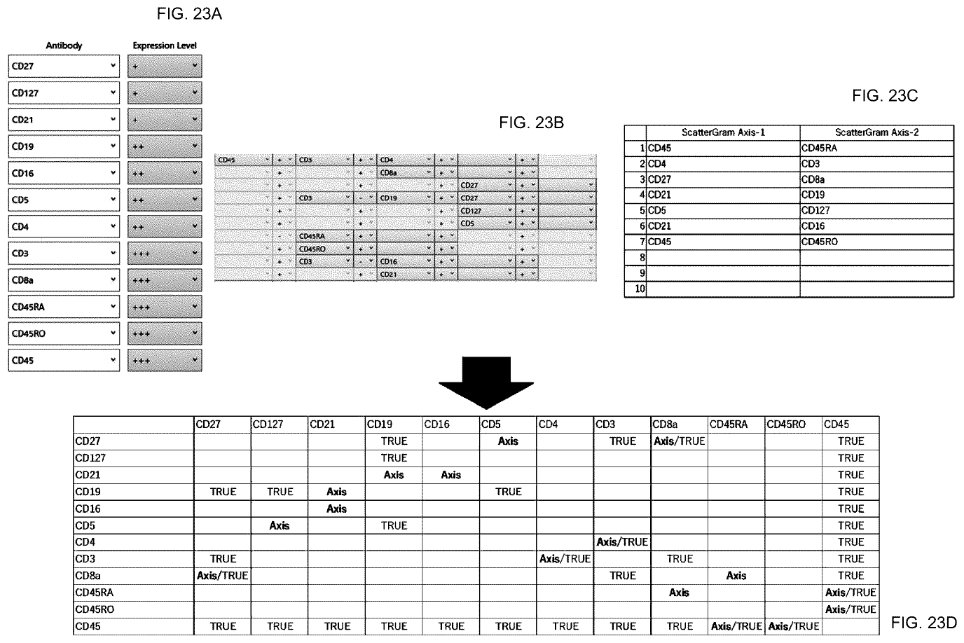

An example of the extraction processing will be described with reference to FIGS. 22 and 23. FIG. 22 is an example of a window to which the assumed measurement result data is input. A of FIG. 23 illustrates the input results of the plurality of biomolecules and the expression levels of the plurality of biomolecules input in step S401. B of FIG. 23 illustrates an example of extracted expression relationship information from the window illustrated in FIG. 22. C of FIG. 23 illustrates an example of the combination information extracted from the window illustrated in FIG. 22. D of FIG. 23 illustrates an example of the specifying result of the biomolecule pairs based on the expression relationship information and the combination information.

The setting and development of the gate in the assumed measurement result data illustrated in FIG. 22 will be described below.

The scattergram schematic diagram 0 in FIG. 22 adopts CD45 and CD45RA as axes. In the scattergram schematic diagram 0, a circle indicating the distribution of the CD45-positive and CD45RA-negative cell population and a circle indicating the CD45-positive and CD45RA-positive cell population are drawn.

Furthermore, in the scattergram schematic diagram 0, a rectangular gate 1 is set for the circle indicating the distribution of the CD45-positive and CD45RA-negative cell population. The rectangular gate 1 is developed to generate a scattergram schematic diagram 1.

The scattergram schematic diagram 1 adopts CD3 and CD4 as axes. In the scattergram schematic diagram 1, a circle indicating a CD3-positive and CD4-positive cell population is drawn. Furthermore, in the scattergram schematic diagram 1, a circle indicating a CD3-positive and CD4-negative cell population and a circle indicating a CD3-negative and CD4-negative cell population are also drawn.

Furthermore, rectangular gates 2, 3, and 5 are set in the scattergram schematic diagram 1. The rectangular gate 2 is a gate set for the CD3-positive and CD4-negative cell population. Both rectangular gates 3 and 5 are gates set for CD3-negative and CD4-negative cells. The rectangular gates 2, 3, and 5 are respectively developed to generate scattergram schematic diagrams 2, 3, and 5.

The scattergram schematic diagram 2 adopts CD8a and CD27 as axes. In the scattergram schematic diagram 2, a circle indicating a CD8a-positive and CD27 negative cell population and a circle indicating a CD8a-positive and CD27 positive cell population are drawn.

The scattergram schematic diagram 3 adopts CD19 and CD27 as axes. In the scattergram schematic diagram 3, a circle indicating a CD19-positive and CD27-negative cell population, a circle indicating a CD19-positive and CD27-positive cell population, and a circle indicating a CD19-negative and CD27-negative cell population are drawn.

Furthermore, a rectangular gate 4 is set for a CD19-positive and CD27-negative cell population. The rectangular gate 4 is developed to generate a scattergram schematic diagram 4.

The scattergram schematic diagram 4 adopts CD127 and CD5 as axes. In the scattergram schematic diagram 4, a circle indicating a CD127-positive and CD5-negative cell population, a circle indicating a CD127-negative and CD5-negative cell population, and a circle indicating a CD127-negative and CD5-positive cell population are drawn.

The scattergram schematic diagram 5 adopts CD16 and CD21 as axes. In the scattergram schematic diagram 5, a circle indicating a CD16-positive and CD21-negative cell population, a circle indicating a CD16-negative and CD21-negative cell population, and a circle indicating a CD16-negative and CD21-positive cell population are drawn.

Furthermore, in the scattergram schematic diagram 5, a rectangular gate 6 is set for a CD16-negative and CD21-negative cell population. The rectangular gate 6 is developed to generate a scattergram schematic diagram 6.

In the scattergram schematic diagram 6, CD45RO and CD45 are adopted as axes. In the scattergram schematic diagram 6, a circle indicating a CD45RO-positive and CD45-positive cell population is drawn.

For the assumed measurement result data represented by the scattergram schematic diagrams 0 to 6 in FIG. 22, the user selects circles indicating the cell populations from which the expression relationship information is to be extracted. The processing unit 101 extracts the expression relationship information of the bioparticle population corresponding to each of the selected circles.

For example, the processing unit 101 can refer to a scattergram schematic diagram and a gate used to form a certain selected circle and extract expression relationship information from the scattergram schematic diagram and the gate.

For example, in FIG. 22, it is assumed that the user selects a circle 1. In this case, the processing unit 101 specifies, as the scattergram schematic diagrams used to form the circle 1, the scattergram schematic diagram 2, the scattergram schematic diagram 1 (including the rectangular gate 2 that is the source of the development of the scattergram 2), and the scattergram schematic diagram 0 (including the rectangular gate 1 that is the source of the development of the scattergram 1). Furthermore, the processing unit 101 specifies the rectangular gate 2 and the rectangular gate 1 as the gates used to form the circle 1. The processing unit 101 can extract, as the expression relationship information, the biomolecules adopted as the axes of the scattergram schematic diagrams 2, 1, and 0 specified as described above, the presence or absence of expression of the biomolecules of the axes of the scattergram schematic diagram 2 for the circle 1, the presence or absence of expression of the biomolecules of the axes of the scattergram schematic diagram 1 for the gate 2, and the presence or absence of expression of the biomolecules of the axes of the scattergram schematic diagram 0 for the gate 1.

Expression relationship information may be similarly extracted for all other selected circles 2 to 10 as well.

Note that, in the extraction processing, a biomolecule of any one of the two axes of each scattergram schematic diagram and the presence or absence of expression thereof may be extracted as the expression relationship information, or the biomolecules of both axes and the presence or absence of expression thereof may be extracted as the expression relationship information. The axis to be referred to and the axis not to be referred to in the extraction may be appropriately selected by the user.

An example of the expression relationship information of the selected circles 1 to 10 extracted from the assumed measurement result data illustrated in FIG. 22 is illustrated in B of FIG. 23. Each of the first to tenth rows in B of FIG. 23 corresponds to the circles 1 to 10.

As described above, the processing unit 101 can extract the expression relationship information from the assumed measurement result data.

Furthermore, the processing unit 101 can extract a combination of two biomolecules adopted as each axis of the scattergram schematic diagrams 0 to 6 as combination information regarding a combination of biomolecules to be output. For example, a combination of CD45RA and CD45 can be extracted as the combination information from the scattergram schematic diagram 0. The combination information can be similarly extracted from the other scattergram schematic diagrams 1 to 6.

An example of combination information regarding the scattergram schematic diagrams 0 to 6 extracted from the assumed measurement result data illustrated in FIG. 22 is illustrated in C of FIG. 23. The first to seventh rows in C of FIG. 23 correspond to the scattergram schematic diagrams 0 to 6, respectively.

The expression relationship information and/or combination information extracted as described above is used for specifying the biomolecule pairs in step S409. The specifying method may be as described above in (3-4). The specific result is illustrated in D of FIG. 23. Using the specific result, the separation ability may be evaluated in step S409.

### (3-6) Example of Processing by Processing Unit (Input of Expression Relationship Information Based on Measurement Result)

In the above (3-5), expression relationship information and/or combination information is extracted from measurement result data assumed to be acquired. In the present technology, the expression relationship information and/or the combination information may be extracted from the acquired measurement result data. Such extraction can also improve convenience for the user.

In a preferred embodiment of the present technology, the expression relationship information and/or the combination information may include data extracted from acquired measurement result data. In this implementation, the processing unit 101 may perform a data acquisition step of acquiring measurement result data. In this embodiment, the processing unit 101 can execute an extraction step of extracting expression relationship information and/or combination information from the acquired measurement result data. In this embodiment, by using the acquired measurement result data, the input operation as described in (3-2) and (3-5) above can be omitted, and convenience for the user is improved. The processing unit 101 can evaluate the separation ability related to the combination list by using the extracted expression relationship information.

In this embodiment, measurement result data appropriately selected by the user may be used as the acquired measurement result data. Said acquired measurement result data includes, for example, one or a plurality of scattergrams, in particular a plurality of scattergrams. Each scattergram may be a scattergram in which any two of the plurality of biomolecules are adopted as axes. Each scattergram may be, for example, a dot plot or a contour plot.

The data acquisition step and the extraction step in this embodiment can be performed in, for example, step S102 described in the above (3-2) or step S402 described in the above (3-4).

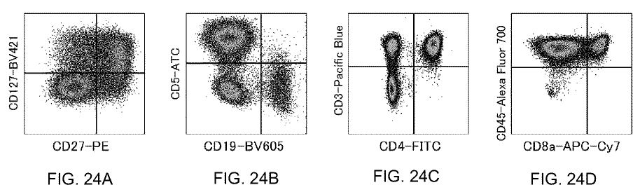

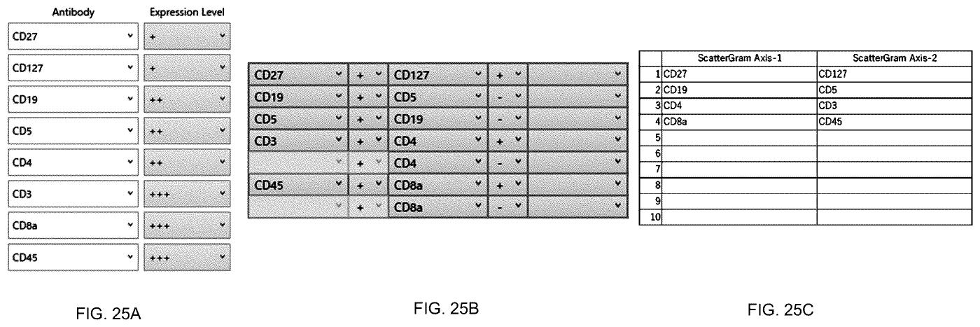

An example of a case where the data acquisition step and the extraction step are performed in step S402 will be described below with reference to FIGS. 24 and 25.

In the data acquisition step, the processing unit 101 acquires measurement result data. The data is treated as acquired measurement result data in the next extraction step. An example of the acquired measurement result data is illustrated in FIG. 24. The measurement result data includes 4 scattergrams as illustrated in FIG. 24. As illustrated in the figure, each scattergram adopts two biomolecules as axes.

In the extraction step, the processing unit 101 extracts expression relationship information and/or combination information from the measurement result data (which is “acquired measurement result data”) acquired in the data acquisition step.

The processing unit 101 specifies a region satisfying a predetermined condition from the acquired measurement result data. The region can be, for example, a region where the relative intensity of the event density is equal to or greater than a predetermined value.

In FIG. 24A, it is assumed that the region is formed by a CD27-positive and CD127-positive bioparticle. The processing unit 101 specifies that the region exists in the scattergram of FIG. 24A. Therefore, the processing unit 101 extracts expression relationship information from the scattergram. For example, CD27 and CD127, which are biomolecules adopted as axes of the scattergram, and the presence or absence of expression of these biomolecules are extracted as the expression relationship information.

From FIGS. 24B to 24D, the processing unit 101 similarly extracts expression relationship information.

An example of expression relationship information extracted from the scattergrams of FIGS. 24A to 24D is illustrated in B of FIG. 25. Note that A of FIG. 25 illustrates the input results of the plurality of biomolecules and the expression levels of the plurality of biomolecules input in step S401.

Furthermore, the processing unit 101 can extract a combination of two biomolecules adopted as axes of the scattergrams in FIGS. 24A to 24D as combination information regarding a combination of biomolecules to be output. For example, a combination of CD27 and CD127 can be extracted as the combination information from the scattergram in FIG. 24A. Similarly, combination information can be extracted from the scattergrams in FIGS. 24B to 24D.

An example of combination information extracted from the scattergrams illustrated in FIGS. 24A to 24D is illustrated in C of FIG. 25. The first to fourth rows in C of FIG. 25 correspond to the scattergrams of A to D of FIG. 24, respectively.

The expression relationship information and/or combination information extracted as described above is used for specifying the biomolecule pairs in step S409. The specifying method may be as described above in (3-4).

### (3-7) Example of Processing by Processing Unit (FMO Simulation)

In step S112 described in (3-2) above, the processing unit 101 may perform the fluorescence separation simulation and then cause the output device to output the result of the fluorescence separation simulation. In one embodiment of the present technology, the processing unit 101 may use, as the simulation data used to execute the fluorescence separation simulation, data (hereinafter, also referred to as “FMO simulation data”) related to particles stained with a one-color absent fluorophore group in which one fluorophore is absent from among the fluorophore groups constituting the combination list. That is, the processing unit 101 can execute the FMO simulation in step S112.

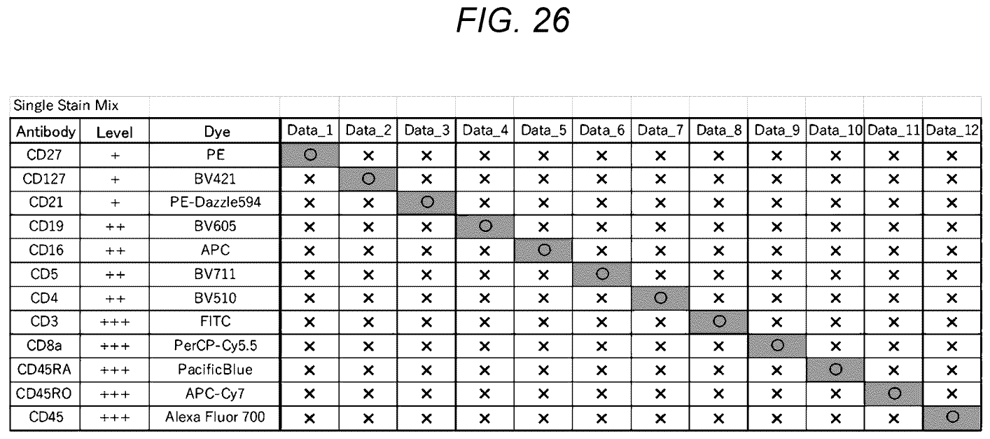

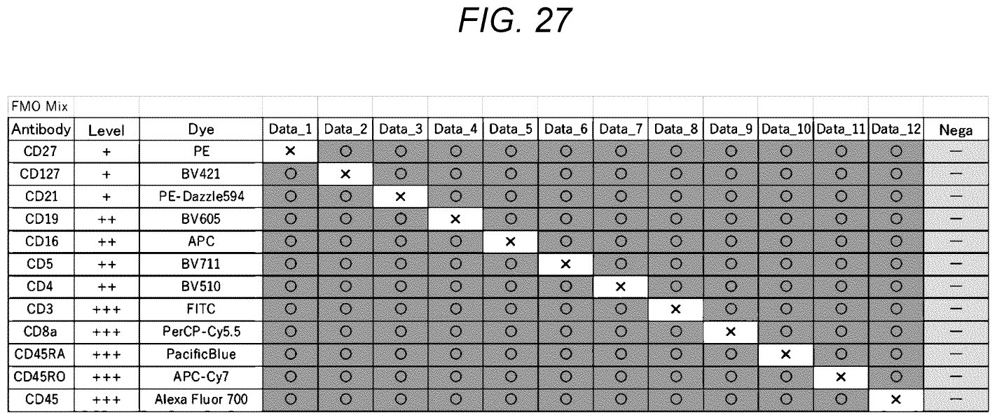

Examples of the single staining simulation data and the FMO simulation data will be described with reference to FIGS. 26 and 27.

FIG. 26 illustrates a configuration example of single staining simulation data. In each row of FIG. 26, the combination of the antibody (Antibody) and the fluorophore (Dye) included in the optimization combination list specified in step S111 and the expression level (Level) of the antigen captured by the antibody are illustrated. As illustrated in the figure, the optimization combination list includes 12 fluorophores. Therefore, the single staining simulation data includes simulation data regarding single stained bioparticles stained with each fluorophore included in the optimization combination list. For example, Data_1 illustrated in the figure is data on a bioparticle stained only with PE (circles indicate dyes used for staining, and X indicates dyes not used for staining). Similarly, Data_2 to Data 12 are data on a bioparticle stained with one dye.

FIG. 27 illustrates a configuration example of the FMO simulation data. In each row of FIG. 27, the combination of the antibody (Antibody) and the fluorophore (Dye) included in the optimization combination list specified in step S111 and the expression level (Level) of the antigen captured by the antibody are also illustrated. As illustrated in the figure, the optimization combination list includes 12 fluorophores. Therefore, the FMO simulation data includes simulation data related to the multi-stained bioparticle stained with the fluorophores removing one from all the fluorophores included in the optimization combination list. For example, Data_1 illustrated in the figure is data related to bioparticles stained with 11 fluorophores excluding one fluorophore similarly for Data_2 to Data_12 which are data related to bioparticles stained with 11 fluorophores other than PE.

In general, even in a panel in which an acceptable evaluation result has been obtained to some extent in the separation ability evaluation in simulation, separation performance tends to deteriorate due to variations in cells and/or staining variations in experiments actually using cells. Therefore, it is important to perform a panel separation ability evaluation simulation under conditions where separation is more difficult.

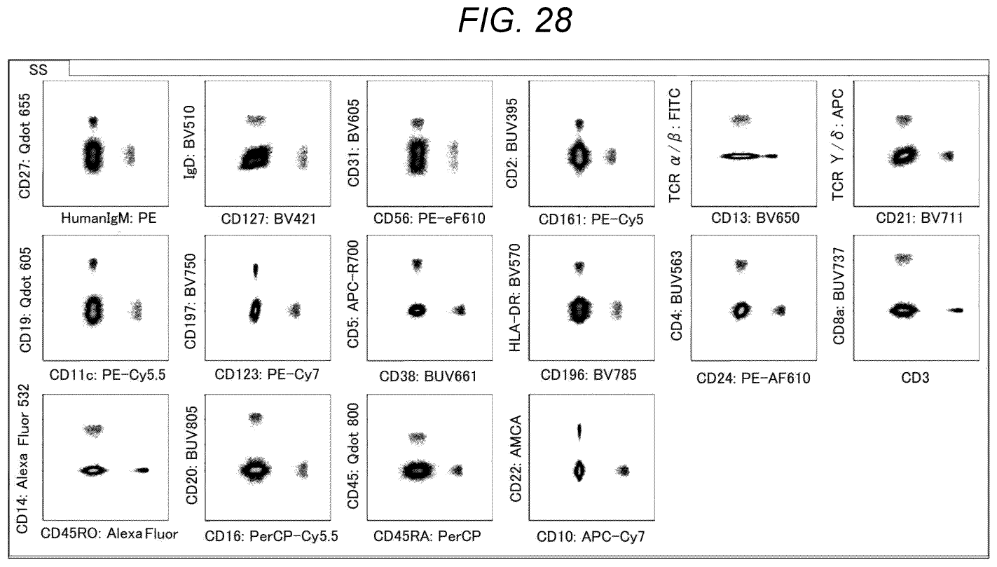

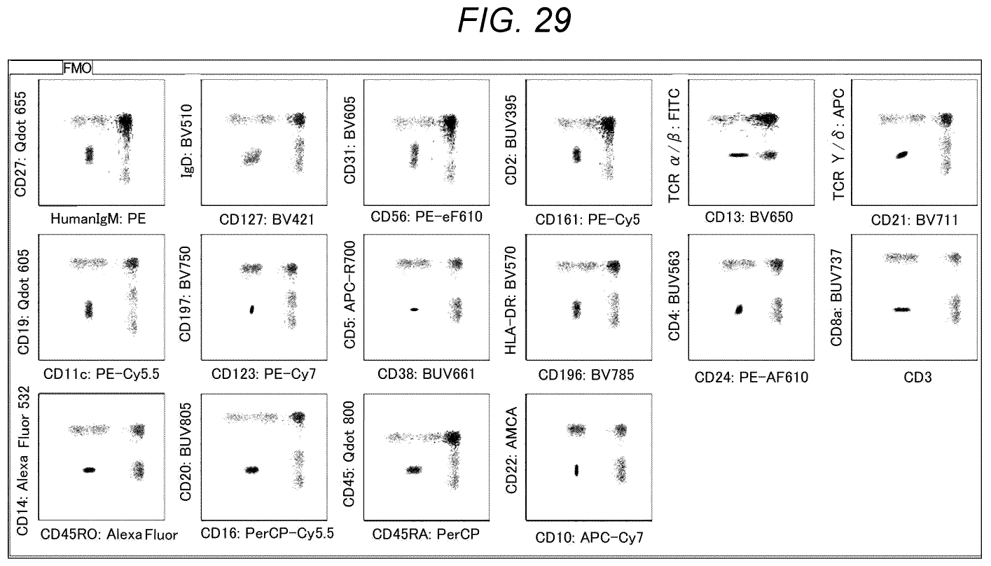

Since the influence of the leakage amount is larger in the case of multiple staining than in the case of single staining, it is more difficult to separate different bioparticle populations. FIGS. 28 and 29 illustrate single staining simulation results and FMO simulation results for the same panel, respectively. It can be seen that the results illustrated in FIG. 29 illustrate that different bioparticle populations are not more separated than the results illustrated in FIG. 28. Since the FMO simulation is a simulation for a case where separation is more difficult, it is possible to increase the possibility of obtaining good results in an actual experiment by performing the FMO simulation.

### (3-8) Example of Processing by Processing Unit (Dimensional Compression)

In step S112 described in (3-2) above, the processing unit 101 may perform the fluorescence separation simulation and then cause the output device to output the result of the fluorescence separation simulation. In one embodiment of the present technology, the processing unit 101 can cause an output device to output a distribution diagram obtained by dimensionally compressing a result of the fluorescence separation simulation. Therefore, the optimization result of the panel can be visualized.

The dimensional compression may be, for example, t-Distributed Stochastic Neighbor Embedding (tSNE), Umap, TriMap, FlowSOM, Phenograph, Isomap, Spectral Embedding, or Locally Linear Embedding (LLE), and is preferably tSNE dimensional compression.

Preferably, the fluorescence separation simulation result to be dimensionally compressed preferably includes a scattergram group obtained by performing unmixing processing on the simulation data, and for example, includes a scattergram group obtained by performing unmixing processing on the FMO simulation data and/or a scattergram group obtained by performing unmixing processing on the single staining simulation data.

Particularly preferably, the processing unit 101 can cause the output device to output the distribution diagram obtained by performing the tSNE dimensional compression on the scattergram group obtained by performing the unmixing processing on the FMO simulation data. Therefore, the optimization result of the panel can be visualized more easily, and the separation degree of the distribution can be quantified. That is, in the present technology, the processing unit 101 may cause the output device to output the separation degree of each cluster in the distribution diagram acquired by dimensionally compressing the result of the fluorescence separation simulation as a numerical value.

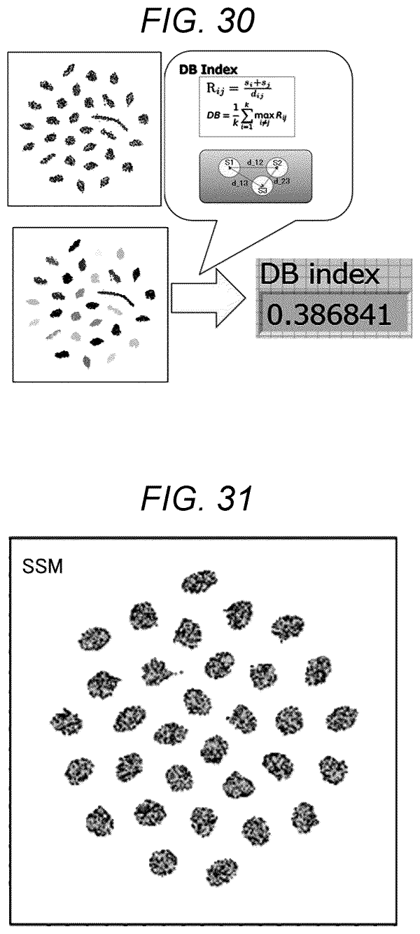

Quantification of the separation degree will be described with reference to FIG. 30. An example of a distribution diagram generated by tSNE dimensional compression is illustrated on the left of FIG. 30. As illustrated in the figure, there is a plurality of clusters in the distribution diagram. In the distribution diagram, it is preferable that clusters are further separated and points constituting each cluster are more convergent. From this viewpoint, DB-Index can be adopted as an index for evaluating the separation degree of the distribution diagram. The DB-Index is an index based on a distance between a certain cluster and a cluster having the closest centroid from the centroid of the certain cluster, and is expressed by the following formulas as illustrated in FIG. 29. DB-Index means that different distributions are arranged at different positions as the value is smaller, and it can be determined that the separation performance is good.

$${R}_{ij} = \frac{{S}_{i} + {S}_{j}}{{d}_{ij}} \qquad [ Mathematical Formula 2 ]$$

$$DB = \frac{1}{k} {\sum }_{i = 1}^{k} max {R}_{ij} ( i \neq j ) \qquad [ Mathematical Formula 3 ]$$

In Formulas 2 and 3, s is an average of distances from the cluster centroid to each point in the cluster i. Here, the cluster centroid is a center coordinate. Furthermore, dᵢⱼ is a distance between the centroids of the cluster i and the cluster j. k is the number of clusters. DB is a DB-Index.

For example, as illustrated on the right side of FIG. 30, in a case where there are three clusters S1, S2, and S3, R12 and R13 are calculated for the clusters S2 and S3, respectively, focusing on the cluster S1. Then, the largest R is used to calculate the DB.

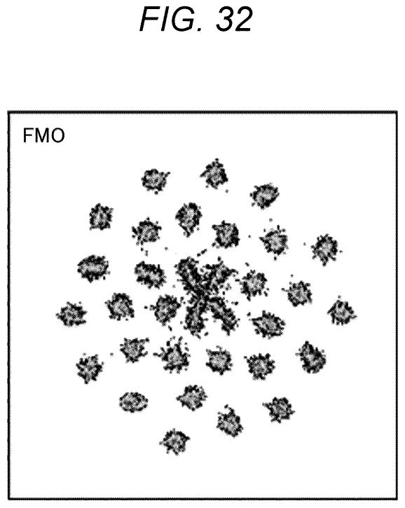

FIGS. 31 and 32 illustrate distribution diagrams obtained by performing tSNE dimensional compression on the single staining simulation results of FIG. 28 and the FMO simulation results of FIG. 29 described in (3-7) above, respectively. From these distribution diagrams, it can be seen that in the FMO simulation, each cluster is not further separated, that is, evaluation is performed under severer conditions. By means of dimensional compression, the separation ability of a panel can be evaluated visually by means of one distribution diagram without comparing a large number of scattergrams.

Furthermore, the separation degree in the distribution diagram obtained by the tSNE dimensional compression of the single staining simulation result was 0.3758, and the separation degree in the distribution diagram obtained by the dimensional compression of the FMO simulation result was 0.5481. From these values, it can be seen that each cluster is not further separated in the FMO simulation, that is, evaluation is performed under more severe conditions. In this manner, by calculating the separation degree from the distribution diagram obtained by the tSNE dimensional compression, the degree of separation can also be determined by a numerical value.

That is, the present technology also provides an evaluation method for evaluating a cluster separation degree in a distribution diagram obtained by performing dimensional compression on a scattergram group by a numerical value. The scattergram group can be obtained by performing unmixing processing on the simulation data corresponding to the panel. Furthermore, the dimensional compression may be tSNE dimensional compression. Furthermore, the numerical value may be DB-Index. The evaluation method may be performed, for example, for evaluation of a panel.

### Example 1: Improvement in Separation Performance by Using Tree Information

According to the present technology, a combination list of fluorophores for biomolecules (hereinafter, referred to as a “combination list of Experimental Example 1”) was generated on the basis of the expression level categories, the brightness categories, the inter-fluorophore correlation information, and the expression relationship information. In the combination list of Experimental Example 1, one fluorescent dye is assigned to each of 32 types of biomolecules, that is, the combination list includes 32 types of fluorescent dyes. Furthermore, a combination list of fluorophores for biomolecules (hereinafter, referred to as a “combination list of Experimental Example 2”) was also generated in the same manner as described above except that the expression relationship information was not used.

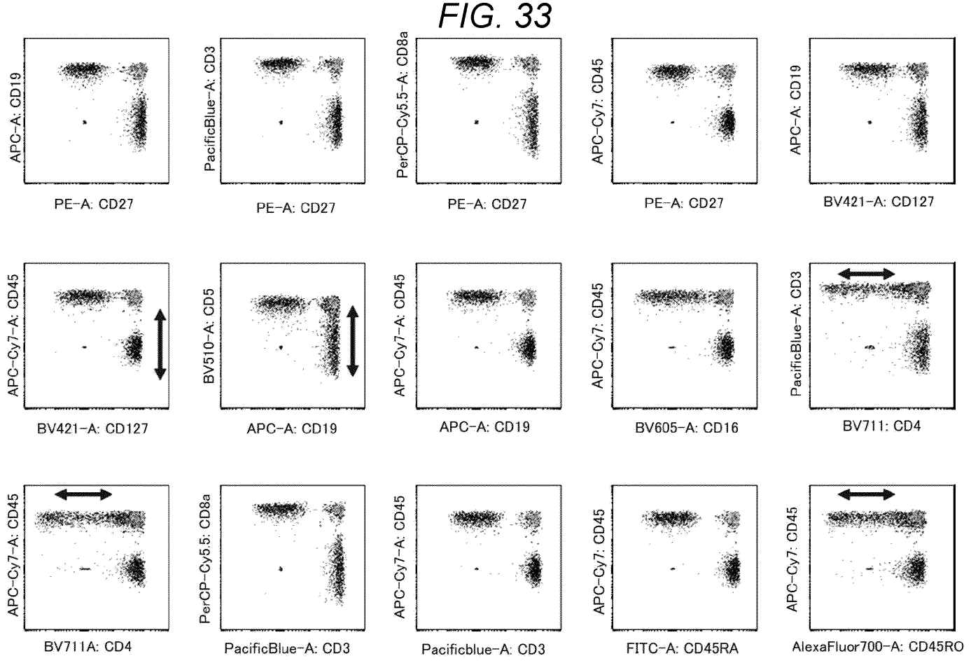

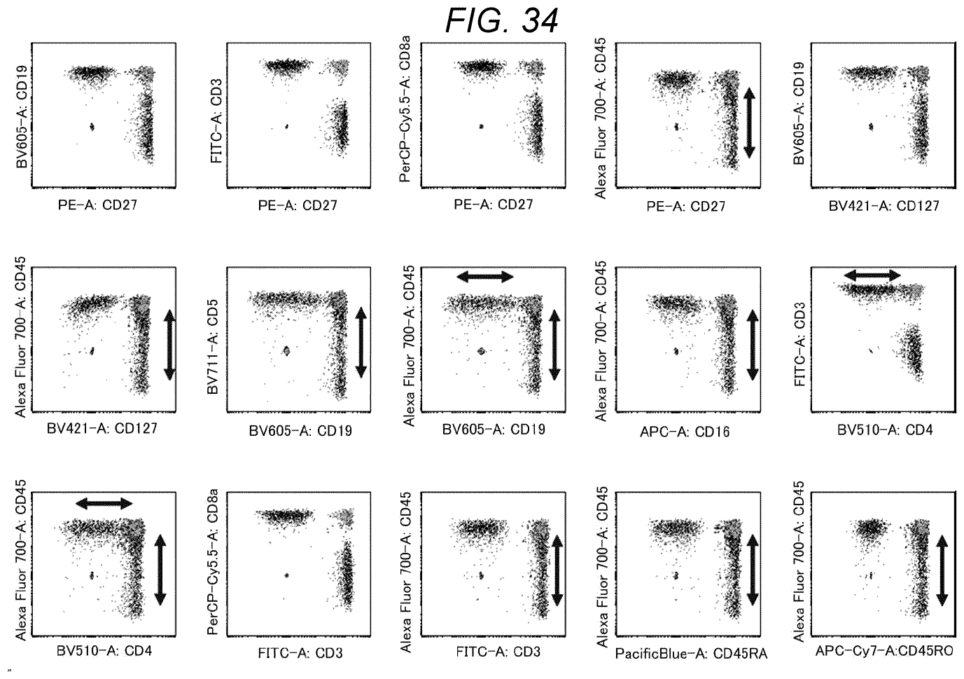

FMO simulation data was generated for each of the combination lists of Experimental Examples 1 and 2, and the data was unmixed to generate scattergrams. The scattergrams are illustrated in FIG. 33 using the combination list of Experimental Example 1. All the scattergrams illustrated in FIG. 33 are for two biomolecule pairs specified by expression relationship information. Also in Experimental Example 2, scattergrams for the biomolecule pairs was generated. The scattergrams are illustrated in FIG. 34. In FIGS. 33 and 34, portions where the separation of the bioparticle populations is unclear are indicated by arrows. From the comparison of FIGS. 33 and 34, the scattergrams generated using the combination list of Experimental Example 1 have less portions in which the separation of the bioparticle populations is unclear as compared with the scattergrams of Experimental Example 2. Therefore, it can be seen that a panel having improved separation performance for a biomolecule pairs to be analyzed can be designed by using the expression relationship information.

### Example 2: Visualization and Quantification of Separation Performance by tSNE Dimensional Compression of FMO Simulation Results

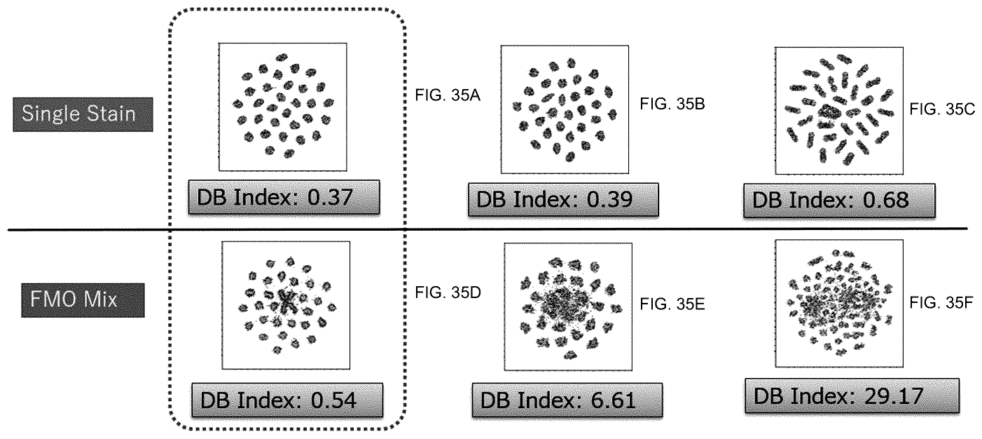

Single staining simulation data was generated for the optimization combination list of fluorophores for biomolecules generated according to the present technology, and unmixing processing was performed on the simulation data to obtain a scattergram group. The obtained scattergram group was subjected to tSNE dimensional compression to obtain a distribution diagram. Furthermore, the DB-Index was calculated from the obtained distribution diagram. The distribution diagram and the value of the DB-Index are illustrated in FIG. 35A.

Furthermore, a modified combination list in which the manner of assignment was changed so that a part of the fluorophores constituting the optimization combination list was assigned to other biomolecules in the list was generated. Furthermore, a random combination list in which fluorescent dyes are randomly assigned to biomolecules constituting the optimization combination list was also generated. For each of the modified combination list and the random combination list, data for single staining simulation was generated similarly to the optimization combination list, and the simulation data was subjected to unmixing processing to obtain a scattergram group. A distribution diagram by tSNE dimensional compression was obtained from the obtained scattergram group, and then the DB-Index was calculated from the distribution diagram. The distribution diagram and the value of DB-Index for the modified combination list are illustrated in FIG. 35B. The distribution diagram and the value of DB-Index for the random combination list are illustrated in FIG. 35C.

FMO simulation data was generated for the optimization combination list, and unmixing processing was performed on the simulation data to obtain a scattergram group. A distribution diagram by tSNE dimensional compression was obtained from the obtained scattergram group, and the DB-Index was further calculated from the distribution diagram. The distribution diagram and the value of the DB-Index are illustrated in FIG. 35D.

Furthermore, similarly, FMO simulation data was generated for the modified combination list and the random combination list, and unmixing processing was performed on the simulation data to obtain a scattergram group. A distribution diagram by tSNE dimensional compression was obtained from the obtained scattergram group, and then the DB-Index was calculated from the distribution diagram. The distribution diagram and the value of DB-Index for the modified combination list are illustrated in FIG. 34E. The distribution diagram and the value of DB-Index for the random combination list are illustrated in FIG. 34F.

Comparing the distribution diagrams of FIGS. 34A and 34B regarding the single staining simulation, there is almost no difference in the degree of convergence of each cluster and the degree of separation between clusters, and the values of DB-Index are almost the same. That is, in the single staining simulation, it can be determined that the separation abilities in the optimization combination list and the modified combination list are almost the same.

Comparing the distribution diagrams of FIGS. 34A and 34B with that of FIG. 34C, in FIG. 34C, each cluster is further spread, and there is a case where the clusters are not separated from each other. Furthermore, the value of the DB-Index of FIG. 34C is slightly larger than the DB-Indexes of FIGS. 34A and 34B. Therefore, in the single staining simulation, it is possible to confirm the difference in the distribution diagrams and deterioration of the DB-Index due to the tSNE dimensional compression by greatly changing the way of assigning the fluorophores to the biomolecules constituting the combination list.

Meanwhile, when comparing the distribution diagrams of FIGS. 34D and 34E related to the FMO simulation, in FIG. 34E, it is apparent at a glance that each cluster is more spread, and it is also immediately visible that there are more clusters that are not separated. Furthermore, the value of the DB-Index of FIG. 34E is significantly larger than the value of the DB-Index of FIG. 34D. Therefore, in the FMO simulation, it is possible to confirm the difference in the distribution diagrams and the deterioration of the DB-Index due to the tSNE dimensional compression only by slightly changing the way of assigning the fluorophore to the biomolecules constituting the combination list.

From the comparison of the distribution diagrams of FIGS. 34D, 34E, and 34F, it is apparent at a glance that in FIG. 34F, the number of unconverged dots is further increased than that in FIG. 34E, and it is also apparent that the number of clusters in which separation between clusters is not made has further increased than that in FIG. 34E. Furthermore, the DB-Index of FIG. 34F is significantly larger than the DB-Indexes of FIGS. 34D and 34E. Therefore, according to the comparison of FIGS. 34D, 34E, and 34F, in the FMO simulation, it is possible to confirm the difference in the distribution diagrams and the deterioration of the DB-Index due to the tSNE dimensional compression as the degree of change in the manner of assigning the fluorophores to the biomolecules constituting the optimization combination list increases.

Furthermore, from a comparison between FIG. 34B (single staining simulation) and FIG. 34E (FMO simulation) for the modified combination list, it can be seen that the FMO simulation can more clearly detect a change in separation ability due to a slight change in the manner of assigning the fluorophores to the biomolecules, as compared with the single staining simulation. The same can be seen from a comparison of FIG. 34C (single staining simulation) and FIG. 34F (FMO simulation) for the random combination list.

As described above, by performing the tSNE dimensional compression on the scattergram obtained by performing the FMO simulation, it is possible to visually and clearly evaluate the separation ability by one distribution diagram without comparing a large number of scattergrams. Furthermore, the separation ability related to the distribution diagram can be quantified, and the quantification provides a more clear determination material related to the separation ability.

### 2. Second Embodiment (Information Processing System)

The present technology also provides an information processing system including the processing unit described in the above “1. First Embodiment (Information Processing Apparatus)”. In addition to the processing unit, the information processing system may include the storage unit, the input unit, the output unit, and the communication unit described above in “1. First Embodiment (Information Processing Apparatus)”. These components may be provided in one device or may be provided in a plurality of devices in a distributed manner. For example, the information processing system of the present technology may include an input unit that receives data input regarding expression levels of a plurality of biomolecules used for analysis of a sample, in addition to the processing unit.

Also by the information processing system according to the present technology, as described above in “1. First Embodiment (Information Processing Apparatus)”, a more appropriate combination list can be generated, and the processing for the generation is more efficiently performed. Therefore, it is possible to automatically perform the optimized panel design. Furthermore, by using the expression relationship information, a more suitable panel is automatically generated, for example, for analysis of expression of a biomolecule to be analyzed.

### 3. Third Embodiment (Information Processing Method)

The present technology also relates to an information processing method. The information processing method includes a list generation step of generating a combination list of fluorophores for a biomolecule on the basis of an expression level category obtained by classifying a plurality of biomolecules used for analysis of a sample on the basis of an expression level in the sample, a brightness category obtained by classifying a plurality of fluorophores usable for analysis of the sample on the basis of brightness, correlation information between the plurality of fluorophores, and expression relationship information of the plurality of biomolecules. In the list generation step, a fluorophore to be assigned to the biomolecule in the combination list is selected from fluorophores belonging to a brightness category associated with an expression level category to which the biomolecule belongs.

Preferably, the processing unit further includes an evaluation step of evaluating separation ability related to the combination list using the expression relationship information.

By generating a combination list of fluorophores for a biomolecule in accordance with the information processing method of the present technology, a more appropriate combination list can be generated, and processing for the generation is more efficiently performed. Therefore, it is possible to automatically perform the optimized panel design. Furthermore, by using the expression relationship information, a more suitable panel is automatically generated, for example, for analysis of expression of a biomolecule to be analyzed.

The list generation step included in the information processing method of the present technology may be executed according to any of the flows described in “1. First Embodiment (Information Processing Apparatus)” above.

The list generation step may include, for example, an expression level category generation step of generating an expression level category in which a plurality of biomolecules used for analysis of a sample is classified on the basis of an expression level in the sample, a brightness category generation step of generating a brightness category in which a plurality of fluorophores usable for analysis of the sample is classified on the basis of brightness, and an assignment step of performing processing of assigning a fluorophore to a biomolecule on the basis of the expression level category, the brightness category, and correlation information between the plurality of fluorophores.

The expression level category generation step may include, for example, a step of executing step S103 described in “1. First Embodiment (Information Processing Apparatus)” above. This step is as described above in “1. First Embodiment (Information Processing Apparatus)”, and the description also applies to the present embodiment.

The brightness category generation step may include, for example, a step of executing step S105 described in “1. First Embodiment (Information Processing Apparatus)” above. This step is as described above in “1. First Embodiment (Information Processing Apparatus)”, and the description also applies to the present embodiment.

The assignment step may include, for example, a step of executing step S108 described in “1. First Embodiment (Information Processing Apparatus)” above. This step is as described above in “1. First Embodiment (Information Processing Apparatus)”, and the description also applies to the present embodiment.

The evaluation step may include, for example, a step of executing steps S109 and 110 described in the above “1. First Embodiment (Information Processing Apparatus)”. The evaluation step may further include a step of executing step S111. The evaluation step is as described above in “1. First Embodiment (Information Processing Apparatus)”, and the description also applies to the present embodiment.

### 4. Fourth Embodiment (Program)

The present technology also provides a program for causing an information processing apparatus to execute the information processing method described in the above 3. The information processing method is as described in the above 1. and 3., and the description also applies to the present embodiment. The program according to the present technology may be recorded in, for example, the recording medium described above, or may be stored in the information processing apparatus described above or a storage unit included in the information processing apparatus described above.

Note that the present technology can also have the following configurations.

[1]

An information processing apparatus including

a processing unit that generates a combination list of fluorophores for a biomolecule on the basis of an expression level category obtained by classifying a plurality of biomolecules used for analysis of a sample on the basis of an expression level in the sample, a brightness category obtained by classifying a plurality of fluorophores usable for analysis of the sample on the basis of brightness, correlation information between the plurality of fluorophores, and expression relationship information of the plurality of biomolecules,

in which the processing unit selects a fluorophore to be assigned to the biomolecule in the combination list from fluorophores belonging to a brightness category associated with an expression level category to which the biomolecule belongs.

[2]

The information processing apparatus according to [1], in which the processing unit evaluates separation ability related to the combination list using the expression relationship information.

[3]

The information processing apparatus according to [2], in which the processing unit specifies a fluorophore pair to be evaluated in evaluation of the separation ability by using the expression relationship information.

[4]

The information processing apparatus according to [3], in which an evaluation index in the evaluation of the separation ability is an inter-fluorophore stain index, and the processing unit refers to an inter-fluorophore stain index of the fluorophore pair specified in the evaluation of the separation ability.

[5]

The information processing apparatus according to any one of [1] to [4], in which the expression relationship information has a tree structure.

[6]

The information processing apparatus according to any one of [1] to [5], in which the expression relationship information includes information regarding presence or absence or degree of expression of each biomolecule.

[7]

The information processing apparatus according to any one of [1] to [6], in which the expression relationship information includes expression relationship information extracted from measurement result data assumed to be acquired.

[8]

The information processing apparatus according to any one of [1] to [7], in which the expression relationship information includes expression relationship information extracted from acquired measurement result data.

[9]

The information processing apparatus according to [7], in which the processing unit causes an output device to output a screen that receives an input of measurement result data assumed to be acquired.

[10]

The information processing apparatus according to [8], in which the processing unit extracts the expression relationship information from the acquired measurement result data, and evaluates the separation ability related to the combination list using the expression relationship information extracted.

[11]

The information processing apparatus according to any one of [3] to [10], in which the processing unit further uses combination information regarding a combination of biomolecules to be output in specifying an evaluation target in the evaluation of the separation ability.

[12]

The information processing apparatus according to [2], in which the processing unit performs evaluation of the separation ability using the expression relationship information for all combination lists that can be generated on the basis of the expression level category and the brightness category.

[13]

The information processing apparatus according to [12], in which the processing unit specifies an optimal combination list from all the combination lists on the basis of an evaluation result of the separation ability.

[14]

The information processing apparatus according to any one of [1] to [13], in which the processing unit causes an output device to output a result of fluorescence separation simulation executed using the combination list.

[15]

The information processing apparatus according to [14], in which the processing unit uses, as simulation data used to execute the fluorescence separation simulation, data related to particles stained by a one-color absent fluorophore group in which one fluorophore is absent from among fluorophore groups constituting the combination list.

[16]

The information processing apparatus according to or [15], in which the processing unit causes an output device to output a distribution diagram obtained by dimensionally compressing a result of the fluorescence separation simulation.

[17]

The information processing apparatus according to any one of [14] to [16], in which the processing unit causes an output device to output, as a numerical value, a separation degree of each cluster in a distribution diagram acquired by dimensionally compressing a result of the fluorescence separation simulation.

[18]

An information processing method including

a list generation step of generating a combination list of fluorophores for a biomolecule on the basis of an expression level category obtained by classifying a plurality of biomolecules used for analysis of a sample on the basis of an expression level in the sample, a brightness category obtained by classifying a plurality of fluorophores usable for analysis of the sample on the basis of brightness, correlation information between the plurality of fluorophores, and expression relationship information of the plurality of biomolecules,

in which in the list generation step, a fluorophore to be assigned to the biomolecule in the combination list is selected from fluorophores belonging to a brightness category associated with an expression level category to which the biomolecule belongs.

[19]

A program for causing an information processing apparatus to execute

a list generation step of generating a combination list of fluorophores for a biomolecule on the basis of an expression level category obtained by classifying a plurality of biomolecules used for analysis of a sample on the basis of an expression level in the sample, a brightness category obtained by classifying a plurality of fluorophores usable for analysis of the sample on the basis of brightness, correlation information between the plurality of fluorophores, and expression relationship information of the plurality of biomolecules,

in which in the list generation step, a fluorophore to be assigned to the biomolecule in the combination list is selected from fluorophores belonging to a brightness category associated with an expression level category to which the biomolecule belongs.

[20]

An information processing apparatus including

a processing unit that executes evaluation of separation ability regarding a combination list of fluorophores for a biomolecule in which a fluorophore is assigned to a plurality of biomolecules used for analysis of a sample,

in which the processing unit evaluate the separation ability related to the combination list using expression relationship information of the plurality of biomolecules.

### REFERENCE SIGNS LIST

100 Information processing apparatus
101 Processing unit
102 Storage unit
103 Input unit
104 Output unit
105 Communication unit

1. An information processing apparatus comprising
a processing unit that generates a combination list of fluorophores for a biomolecule on a basis of an expression level category obtained by classifying a plurality of biomolecules used for analysis of a sample on a basis of an expression level in the sample, a brightness category obtained by classifying a plurality of fluorophores usable for analysis of the sample on a basis of brightness, correlation information between the plurality of fluorophores, and expression relationship information of the plurality of biomolecules,
wherein the processing unit selects a fluorophore to be assigned to the biomolecule in the combination list from fluorophores belonging to a brightness category associated with an expression level category to which the biomolecule belongs.

2. The information processing apparatus according to claim 1, wherein the processing unit evaluates separation ability related to the combination list using the expression relationship information.

3. The information processing apparatus according to claim 2, wherein the processing unit specifies a fluorophore pair to be evaluated in evaluation of the separation ability by using the expression relationship information.

4. The information processing apparatus according to claim 3, wherein an evaluation index in the evaluation of the separation ability is an inter-fluorophore stain index, and
the processing unit refers to an inter-fluorophore stain index of the fluorophore pair specified in the evaluation of the separation ability.

5. The information processing apparatus according to claim 1, wherein the expression relationship information has a tree structure.

6. The information processing apparatus according to claim 1, wherein the expression relationship information includes information regarding presence or absence or degree of expression of each biomolecule.

7. The information processing apparatus according to claim 1, wherein the expression relationship information includes expression relationship information extracted from measurement result data assumed to be acquired.

8. The information processing apparatus according to claim 1, wherein the expression relationship information includes expression relationship information extracted from acquired measurement result data.

9. The information processing apparatus according to claim 7, wherein the processing unit causes an output device to output a screen that receives an input of measurement result data assumed to be acquired.

10. The information processing apparatus according to claim 8, wherein the processing unit extracts the expression relationship information from the acquired measurement result data, and evaluates the separation ability related to the combination list using the expression relationship information extracted.

11. The information processing apparatus according to claim 3, wherein the processing unit further uses combination information regarding a combination of biomolecules to be output in specifying an evaluation target in the evaluation of the separation ability.

12. The information processing apparatus according to claim 2, wherein the processing unit performs evaluation of the separation ability using the expression relationship information for all combination lists that can be generated on a basis of the expression level category and the brightness category.

13. The information processing apparatus according to claim 12, wherein the processing unit specifies an optimal combination list from all the combination lists on a basis of an evaluation result of the separation ability.

14. The information processing apparatus according to claim 1, wherein the processing unit causes an output device to output a result of fluorescence separation simulation executed using the combination list.

15. The information processing apparatus according to claim 14, wherein the processing unit uses, as simulation data used to execute the fluorescence separation simulation, data related to particles stained by a one-color absent fluorophore group in which one fluorophore is absent from among fluorophore groups constituting the combination list.

16. The information processing apparatus according to claim 14, wherein the processing unit causes an output device to output a distribution diagram obtained by dimensionally compressing a result of the fluorescence separation simulation.

17. The information processing apparatus according to claim 14, wherein the processing unit causes an output device to output, as a numerical value, a separation degree of each cluster in a distribution diagram acquired by dimensionally compressing a result of the fluorescence separation simulation.

18. An information processing method comprising
a list generation step of generating a combination list of fluorophores for a biomolecule on a basis of an expression level category obtained by classifying a plurality of biomolecules used for analysis of a sample on a basis of an expression level in the sample, a brightness category obtained by classifying a plurality of fluorophores usable for analysis of the sample on a basis of brightness, correlation information between the plurality of fluorophores, and expression relationship information of the plurality of biomolecules,
wherein in the list generation step, a fluorophore to be assigned to the biomolecule in the combination list is selected from fluorophores belonging to a brightness category associated with an expression level category to which the biomolecule belongs.

19. A program for causing an information processing apparatus to execute
a list generation step of generating a combination list of fluorophores for a biomolecule on a basis of an expression level category obtained by classifying a plurality of biomolecules used for analysis of a sample on a basis of an expression level in the sample, a brightness category obtained by classifying a plurality of fluorophores usable for analysis of the sample on a basis of brightness, correlation information between the plurality of fluorophores, and expression relationship information of the plurality of biomolecules,
wherein in the list generation step, a fluorophore to be assigned to the biomolecule in the combination list is selected from fluorophores belonging to a brightness category associated with an expression level category to which the biomolecule belongs.

20. An information processing apparatus comprising
a processing unit that executes evaluation of separation ability regarding a combination list of fluorophores for a biomolecule in which a fluorophore is assigned to a plurality of biomolecules used for analysis of a sample,
wherein the processing unit evaluate the separation ability related to the combination list using expression relationship information of the plurality of biomolecules.
